(19) United States
(12) Patent Application Publication
(10) Pub. No.: US 2013/0140476 A1
(43) Pub. Date: Jun. 6, 2013

(54) ROTARY VALVE ADAPTER ASSEMBLY WITH PLANETARY GEAR SYSTEM

(71) Applicants: Kevin Burgess, Sheridan, WY (US); David Yakos, Bozeman, MT (US); Bryan Walthall, Bozeman, MT (US)

(72) Inventors: Kevin Burgess, Sheridan, WY (US); David Yakos, Bozeman, MT (US); Bryan Walthall, Bozeman, MT (US)

(73) Assignee: Big Horn Valve, Inc., Sheridan, WY (US)

(21) Appl. No.: 13/356,628

(22) Filed: Jan. 23, 2012

Related U.S. Application Data
(63) Continuation-in-part of application No. 13/310,733, filed on Dec. 3, 2011.

(51) Int. Cl. F16K 31/08; F16K 31/53

(52) U.S. Cl. 251/65; 251/248

(57) ABSTRACT

A rotary valve adapter assembly comprising an adapter plate configured to attach to a rotary valve body, a torque multiplier assembly comprising one or more planetary gear subassemblies, each of which comprises a sun gear, ring gear, and a plurality of planetary gears, a magnetic actuator assembly comprising two sets of magnetically coupled magnets, and a shaft. The magnetic actuator assembly interfaces with the torque multiplier assembly such that when the magnets of the magnetic actuator assembly rotate, they cause the sun gear of a first planetary gear subassembly to rotate and the planetary gears to walk on the ring gear. The shaft interfaces with the carrier of one of the planetary gear subassemblies such that when the carrier rotates, the shaft also rotates, thereby causing the valve to open and close. The assembly further comprises a pressure equalization system comprising a piston and piston spring or spring washer stack.

### CROSS-REFERENCE TO RELATED APPLICATION

This application is a continuation-in-part of U.S. patent application Ser. No. 13/310,733 filed on Dec. 3, 2011.

### BACKGROUND OF THE INVENTION

1. Field of the Invention

The present invention relates generally to the field of valves and, more specifically, to a rotary valve adapter assembly with a planetary gear system.

2. Description of the Related Art

A number of patent applications have been filed for valve actuators that mitigate stem leakage through the use of a magnetic interlock. These actuator chambers either enclose the dynamic seal that is present in every valve around the stem of the valves, or they eliminate the need for the seal entirely. This dynamic seal is known as a packing or mechanical seal. The magnetic interlock is employed to transmit force from outside of the actuator chamber to the inside, thus avoiding the penetration of the chamber wall by a mechanical stem actuator. Penetration of the chamber wall would nullify the purpose for the chamber in the first place—to enclose the dynamic seal around the stem and prevent leakage from the seal.

The problem with the various magnetic actuators proposed is that the amount of force transmitted by the magnets is not adequate to ensure the proper function of the valve. If an actuator is designed to provide adequate force to open and close the valve, the magnet coupling is so large as to make it impractical. Even with the use of modern rare-earth magnets such as Neodymium-Iron-Boron and Samarium-Cobalt, the ability to transmit, adequate force to the valve stem is still difficult. The forces provided by the magnets are only a fraction (usually less than 20%) of the force that a mechanical stem actuator can provide. This does not give the valve operator the confidence that his valve can be opened or closed under situations where high force is required, such as high fluid pressure, dry seals, or debris in the fluid path.

Rather than increasing force by building ever larger magnetic couplings, the present invention incorporates a set of planetary gears to take the force supplied by the inner magnetic coupling and magnify it many times over through gear speed reduction (i.e., the use of reducing gears). For example, through the use of a planetary gear assembly, the rotational movement supplied by the inner magnetic cartridge is reduced three-fold, while at the same time the force supplied by the inner magnetic cartridge is magnified three-fold. This means that by using a planetary gear assembly with a 12:1 ratio (i.e., the outer magnetic cartridge rotates twelve times for every one rotation of the internal thread ring), one can either gain twelve times as much force for the valve stem, or else the strength required of the magnetic coupling can be reduced by twelve times. A reduction in the strength requirement leads to a corresponding reduction in size or mass of the magnetic coupling. This reduction in size is desirable because the magnetic coupling is the most expensive component of the actuator, and its size is generally proportional to its cost.

Through the incorporation of a planetary gear assembly, the present invention provides a magnetically activated valve actuator that can be used in the harshest conditions. Magnetic actuation is no longer appropriate for light applications only. Rather, it is a robust alternative that provides rotational force to the stem that is equivalent to that of dynamically sealed stemmed valves. This innovation is most needed in places like chemical plants, refineries, paint factories, paper mills, etc. where valves are the central workhorses of the plant itself.

In addition to increasing force and/or decreasing the size of the magnetic coupling, the present invention has the advantage of completely containing any leakage of fluids from the valve bonnet. The present invention is intended to be coupled to valves that are used in hazardous fluid or chemical applications, where stem leakage poses a pollution threat to the outside environment or a safety threat to personnel working nearby. At the very least, leakage from stem packings results in the loss of product, which can be costly. Fugitive emissions account for over 125,000 metric tones of lost product per year in the United States alone. Of this amount, the percentage of fugitive emissions that come from valve stems is estimated to be between 60% and 85%. [1, 2]

The threat posed to the environment by leaking valve sterns is great, particularly when the product that is leaked is a fugitive emission, that is, a leaked or spilled product that cannot be collected back from the environment. An example of a fugitive emission would be methane leaking from a valve on a pipeline or in a refinery, in which case the methane immediately goes into the atmosphere and cannot be recaptured. Another example would be crude oil leakage from a valve on an offshore rig, where the oil is carried away by ocean currents and cannot be brought back.

Safety requirements are becoming more stringent with each passing year. Personnel who are required to work near hazardous chemicals—such as operators in a petrochemical plant—are subject to injury from leaking valve stems, especially from reciprocating stems where the hazardous material inside the valve is transported to the outside environment via the stem as it retracts from the valve body. For example, if the valve is handling chlorine, a leaking stem transports it to the outside environment, where it becomes hydrochloric acid when it reacts with moisture in the air. This acid corrodes the stem, which makes it even more difficult to seal as time goes by.

The above examples illustrate the need for leak-free valves. The magnetic actuator of the present invention, described more fully below, is capable of addressing this need by safely enclosing the dynamic (stem) seal of stemmed rotary valves.

### BRIEF SUMMARY OF THE INVENTION

The present invention is a rotary valve adapter assembly comprising: an adapter plate configured to attach to a rotary valve body; a torque multiplier assembly comprising one or ore planetary gear subassemblies, each of which comprises a sun gear, a ring gear, and a plurality of planetary gears; a magnetic actuator assembly comprising two sets of magnetically coupled magnets; and a shaft comprising two ends; wherein the magnetic actuator assembly interfaces with the torque multiplier assembly such that when the magnets of the magnetic actuator assembly rotate, they cause the sun gear of a first planetary gear subassembly to rotate, thereby causing the planetary gears to walk on the ring gear; wherein the planetary gears of each planetary gear subassembly are situated within or on a carrier, and when the planetary gears walk on the ring gear, they cause the carrier to rotate; wherein when the carrier of the first planetary gear subassembly rotates, it causes the sun gear of a second planetary gear subassembly to rotate; and wherein one end of the shaft extends into the carrier of the second planetary gear subassembly such that when the carrier of the second planetary gear subassembly rotates, the shaft also rotates, thereby causing the valve to open and close.

In a preferred embodiment, the invention further comprises a top enclosure and a bottom enclosure containing the planetary gear subassembly(ies), the top enclosure containing a first part of the magnetic actuator assembly and fitting inside of a driver housing, and the driver housing containing a second part of the magnetic actuator assembly. Preferably, the top enclosure has a bottom disc, and the driver housing has a bottom part that rotates on top of the bottom disc of the top enclosure. The driver housing preferably has a top, and the invention further comprises a driver cap that is affixed to the top of the driver housing.

In a preferred embodiment, the invention further comprises an actuator wheel that is connected to the driver housing by actuator spokes such that when the actuator wheel is turned, the driver housing rotates. Preferably, the magnetic actuator assembly comprises a follower support containing a plurality of inner magnets and fitting into the top enclosure and a driver support containing a plurality of outer magnets that are magnetically coupled with the inner magnets such that when the outer magnets in the driver support rotate, the inner magnets in the follower support also rotate, and the driver housing encloses the driver support. A portion of the top enclosure is preferably situated between the inner and outer magnets.

In a preferred embodiment, the invention further comprises a first planetary adapter with two ends, one end of which extends into the follower support and the other end of which extends into the sun gear of the first planetary gear subassembly. Preferably, the invention further comprises a second planetary adapter with two ends, one end of which extends into the carrier of the first planetary gear subassembly and the other end of which extends into the sun gear of the second planetary gear subassembly. The ring gear of each planetary gear subassembly is preferably held stationary within the bottom enclosure.

In a preferred embodiment, the invention further comprises a ring seal around the shaft, and the ring seal is fully enclosed by the top and bottom enclosures. Preferably, the invention further comprises a valve-adapter plate seal between the valve body and the adapter plate. The magnetic actuator assembly preferably comprises a motor actuator assembly.

In a preferred embodiment, the motor actuator assembly comprises a clutch, a motor gear, a motor mounting bracket, a motor ring gear, and a motor, and the motor turns the motor gear, which engages with the motor ring gear, causing it to rotate. Preferably, the motor ring gear is attached to a driver housing containing outer magnets such that when the motor ring gear rotates, it also causes the driver housing to rotate.

In a preferred embodiment, the magnetic actuator assembly comprises a plurality of radial driver magnets held by a radial driver magnet support and a plurality of radial follower magnets held by a radial follower magnet support. Preferably, the radial driver magnets in the radial driver magnet support and the radial follower magnets in the radial follower magnet support are arranged linearly within a top enclosure with a portion of the top enclosure between them, and the radial driver magnets are magnetically coupled to the radial follower magnets. The radial driver magnet support is preferably inserted into a top part of the top enclosure, and the radial follower magnet support is preferably inserted into a bottom part of the top enclosure.

In a preferred embodiment, the invention further comprises a radial driver magnet cap that is situated on top of the top enclosure, and a wheel actuator is attached to the radial driver magnet cap by actuator spokes such that when the wheel actuator is turned, it causes the radial driver magnets and the radial follower magnets to rotate. Preferably, the invention further comprises a planetary adapter with two ends, one end of which extends into the radial follower magnet support and the other end of which extends into the sun gear of a first planetary gear subassembly. The magnetic actuator assembly preferably comprises a motor actuator assembly.

In a preferred embodiment, the motor actuator assembly comprises a motor, a clutch, and a motor coupler, the motor causes the motor coupler to rotate, the motor coupler is attached to a radial driver magnet cap such that when the motor coupler rotates, it causes the radial driver magnet cap to rotate at the same rate as the motor, the radial driver magnet cap is attached to a top enclosure, and the top enclosure contains the radial driver magnets and radial follower magnets.

In a preferred embodiment, the invention is a rotary valve adapter assembly comprising: an adapter plate configured to attach to a rotary valve body; a torque multiplier assembly comprising a planetary gear subassembly having a sun gear, a ring gear, and a plurality of planetary gears; a magnetic actuator assembly comprising two sets of magnetically coupled magnets; and a shaft comprising two ends; the magnetic actuator assembly interfaces with the torque multiplier assembly such that when the magnets of the magnetic actuator assembly rotate, they cause the sun gear of the planetary gear subassembly to rotate, thereby causing the planetary gears to walk on the ring gear; the planetary gears of the planetary gear subassembly are situated within or on a carrier, and when the planetary gears walk on the ring gear, they cause the carrier to rotate; and one end of the shaft extends into the carrier of the planetary gear subassembly such that when the carrier of the planetary gear subassembly rotates, the shaft also rotates, thereby causing the valve to open and close.

In a preferred embodiment, the invention further comprises a top enclosure and a bottom enclosure containing the planetary gear subassembly, the top enclosure containing a first part of the magnetic actuator assembly and fitting inside of a driver housing, and the driver housing containing a second part of the magnetic actuator assembly. Preferably, the top enclosure has a bottom disc, and the driver housing has a bottom part that rotates on top of the bottom disc of the top enclosure. The driver housing preferably has a top, and the invention further comprises a driver cap that is affixed to the top of the driver housing.

In a preferred embodiment, the invention further comprises an actuator wheel that is connected to the driver housing by actuator spokes such that when the actuator wheel is turned, the driver housing rotates. Preferably, the magnetic actuator assembly comprises a follower support containing a plurality of inner magnets and fitting into the top enclosure and a driver support containing a plurality of outer magnets that are magnetically coupled with the inner magnets such that when the outer magnets in the driver support rotate, the inner magnets in the follower support also rotate, and the driver housing encloses the driver support. A portion of the top enclosure is preferably situated between the inner and outer magnets.

In a preferred embodiment, the invention further comprises a first planetary adapter with two ends, one end of which extends into the follower support and the other end of which extends into the sun gear of the planetary gear subassembly. Preferably, the ring gear of the planetary gear subassembly is held stationary within the bottom enclosure.

In a preferred embodiment, the invention further comprises a ring seal around the shaft, and the ring seal is fully enclosed by the top and bottom enclosures. Preferably, the invention further comprises a valve-adapter plate seal between the valve body and the adapter plate. The magnetic actuator assembly preferably comprises a motor actuator assembly.

In a preferred embodiment, the motor actuator assembly comprises a clutch, a motor gear, a motor mounting bracket, a motor ring gear, and a motor, and the motor turns the motor gear, which engages with the motor ring gear, causing it to rotate. Preferably, the motor ring gear is attached to a driver housing containing outer magnets such that when the motor ring gear rotates, it also causes the driver housing to rotate.

In a preferred embodiment, the magnetic actuator assembly comprises a plurality of radial driver magnets held by a radial driver magnet support and a plurality of radial follower magnets held by a radial follower magnet support. Preferably, the radial driver magnets in the radial driver magnet support and the radial follower magnets in the radial follower magnet support are arranged linearly within a top enclosure with a portion of the top enclosure between them, and the radial driver magnets are magnetically coupled to the radial follower magnets. The radial driver magnet support is preferably inserted into a top part of the top enclosure, and the radial follower magnet support is preferably inserted into a bottom part of the top enclosure.

In a preferred embodiment, the invention further comprises a radial driver magnet cap that is situated on top of the top enclosure, and a wheel actuator is attached to the radial driver magnet cap by actuator spokes such that when the wheel actuator is turned, it causes the radial driver magnets and the radial follower magnets to rotate. Preferably, the invention further comprises a planetary adapter with two ends, one end of which extends into the radial follower magnet support and the other end of which extends into the sun gear of the planetary gear subassembly. The magnetic actuator assembly preferably comprises a motor actuator assembly.

In a preferred embodiment, the motor actuator assembly comprises a motor, a clutch, and a motor coupler, the motor causes the motor coupler to rotate, the motor coupler is attached to a radial driver magnet cap such that when the motor coupler rotates, it causes the radial driver magnet cap to rotate at the same rate as the motor, the radial driver magnet cap is attached to a top enclosure, and the top enclosure contains the radial driver magnets and radial follower magnets.

### BRIEF DESCRIPTION OF THE DRAWINGS

FIG. 1 is a perspective view of the present invention in a fully assembled state.

FIG. 2 is a side view of the present invention in a fully assembled state.

FIG. 3 is an exploded view of the present invention.

FIG. 4 is a section view of the adapter plate assembly of the present invention.

FIG. 5 is an exploded view of the adapter plate assembly of the present invention.

FIG. 6 is an exploded view of the actuator assembly of the present invention.

FIG. 7 is a section view of the actuator assembly of the present invention.

FIG. 8 is an exploded view of the torque multiplier assembly of the present invention.

FIG. 9 is an exploded view of the planetary gear subassembly of the torque multiplier assembly of the present invention.

FIG. 10 is a section view of the planetary gear subassembly of the torque multiplier assembly of the present invention.

FIG. 11 is a detail perspective view of two planetary gear subassemblies and the planetary adapter of the torque multiplier assembly of the present invention.

FIG. 12 is a perspective view of the inner magnets, follower support, planetary adapters, planetary gear subassembly, shaft, and ball of the present invention.

FIG. 13 is a section view of the actuator assembly and torque multiplier assembly of the present invention.

FIG. 14 is a cropped section view of the present invention in a fully assembled state.

FIG. 15 is a detail perspective view of the top enclosure, bottom enclosure, o-rings, valve body, ring seal, valve-adapter plate seal, shaft, and adapter plate of the present invention.

FIG. 16 is a perspective view of the shaft with a positive stop and adapter plate with a positive stop.

FIG. 17 is a detail perspective view of the shaft with a positive stop and adapter plate with a positive stop with the valve in an open position.

FIG. 18 is a detail perspective view of the shaft with a positive stop and adapter plate with a positive stop with the valve in a closed position.

FIG. 19 is a perspective view of the present invention shown with a motor actuator assembly.

FIG. 20 is an exploded view of the motor actuator assembly of the present invention.

FIG. 21 is a section view of the motor actuator assembly of the present invention.

FIG. 22 is a perspective view of the present invention shown attached to a butterfly valve.

FIG. 23 is a perspective cut-away view of the present invention shown attached to a plug valve.

FIG. 24 is a perspective view of the present invention shown with a radial magnet actuation system.

FIG. 25 is a perspective cut-away view of the radial magnet actuation system.

FIG. 26 is an exploded view of the present invention shown with a radial magnet actuation system.

FIG. 27 is a section view of the present invention shown with a radial magnet actuation system.

FIG. 28 is a perspective view of the present invention on a butterfly valve, shown with a radial magnet actuation system.

FIG. 29 is a perspective view of the present invention on a plug valve, shown with a radial magnet actuation system.

FIG. 30 is a perspective view of the present invention shown with a radial magnet actuation system and a motor actuator assembly.

FIG. 31 is an exploded view of the present invention shown with a radial magnet actuation system and a motor actuator assembly.

FIG. 32 is a section view of an alternate embodiment of the present invention comprising a pressure equalization system.

FIG. 33 is an exploded view of the pressure equalization system of the present invention.

FIG. 34 is a perspective cut-away view of the pressure equalization system of the present invention.

FIG. 35 is a perspective cut-away view of an alternate embodiment of the pressure equalization system comprising a spring washer stack.

FIG. 36 is a perspective cut-away view of an alternate embodiment of the pressure equalization system comprising a pressure equalization enclosure and a pressure equalization lid.

FIG. 37 is a perspective cut-away view of an alternate embodiment of the pressure equalization system in which the pressure equalization lid is omitted.

FIG. 38 is an exploded view of the pressure equalization system shown in FIG. 36.

### REFERENCE NUMBERS

1 Valve body
2 Left flange
3 Right flange
4 Trunnion cover
5 Ball
6 Shaft
6a Shaft recess
6b Shaft driver
7 Trunnion
8 Adapter plate
8a Cutout (in adapter plate)
8b Protrusion (into cutout in adapter plate)
9 Bottom enclosure
9a Ridges (of bottom enclosure)
10 Top enclosure
10a Bottom disc (of top enclosure)
11 Driver housing
11a Bottom part (of driver housing)
12 Driver support
13 Driver cap
14 Outer magnet
15 Follower support
15a Socket (of follower support)
16 Inner magnet
17 Carrier
17a Socket (of carrier)
17b Aperture (of carrier)
18 Planetary plate
18a Aperture (in planetary plate)
18b Center aperture (in planetary plate)
19 Planetary adapter
20 Planetary gear
20a Axle (of planetary gear)
21 Sun gear
22 Ring gear
22a internal thread (on ring gear)
22b Channel (on ring gear)
23 Seat
24 Rubber spring gasket
25 Ring seal
26 Valve-adapter plate seal
27 Actuator spoke
28 Actuator wheel
29 Clutch
30 Motor gear
31 Motor mounting bracket
32 Motor ring gear
33 Motor
33a Motor drive shaft (corresponding to motor 33)
34 Bolt
35 Hex nut
37 O-ring
39 Driver cap
40 Stud
41 Adapter plate assembly
42 Torque multiplier assembly
43 Cylindrical magnet wheel actuator assembly
44 Planetary gear subassembly
45 Butterfly valve assembly
46 Plug valve assembly
47 Cylindrical magnet motor actuator assembly
48 Radial magnet wheel actuator assembly
49 Radial driver magnet
50 Radial follower magnet
51 Top enclosure (alternate embodiment with radial magnets)
52 Butterfly valve body
53 Butterfly disc
54 Butterfly valve cover
55 Plug valve body
56 Plug
57 Plug valve cover
58 Radial driver magnet support
59 Radial driver magnet cap
60 Radial follower magnet support
61 Radial magnet motor actuator assembly
62 Motor (alternate embodiment with radial magnets)
62a Motor drive shaft (corresponding to motor 62)
63 Motor Enclosure
64 Top Enclosure (alternate embodiment for radial magnets with motor actuator)
65 Motor coupler
66 Set Screw
67 Clutch (alternate embodiment for radial magnets with motor actuator)
68 Piston
68a Top face (of piston)
68b Center aperture (in piston)
69 Piston spring
70 Adapter plate (first alternate embodiment)
70a Ceiling (of adapter plate)
72 Adapter plate (third alternate embodiment)
73 Grease fitting
74 Spring washer stack
75 Enclosure
76 Pressure equalization enclosure
76a Lip (of pressure equalization enclosure)
77 Pressure equalization lid

### DETAILED DESCRIPTION OF INVENTION

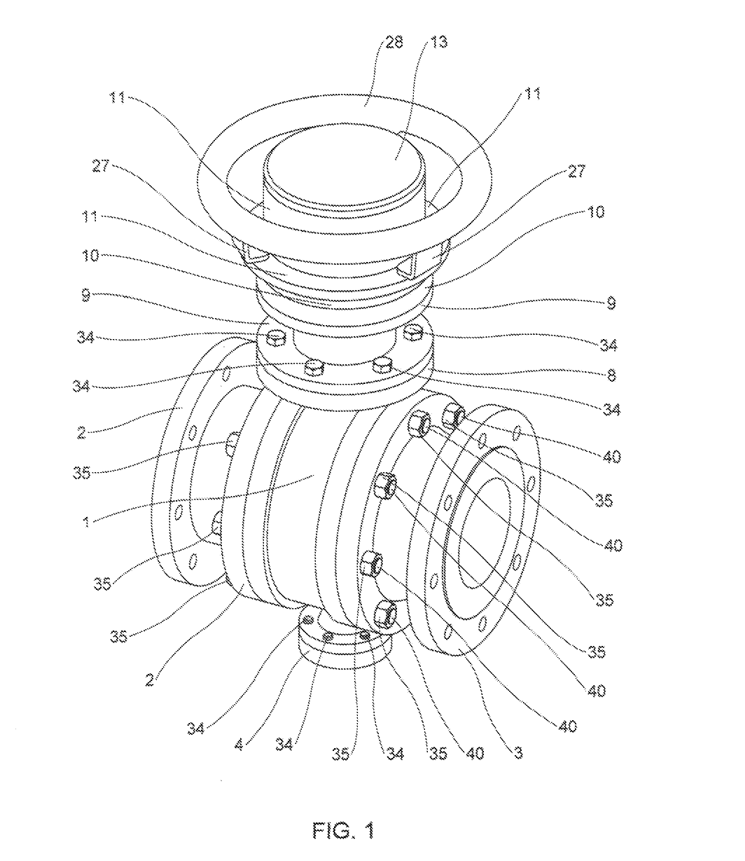

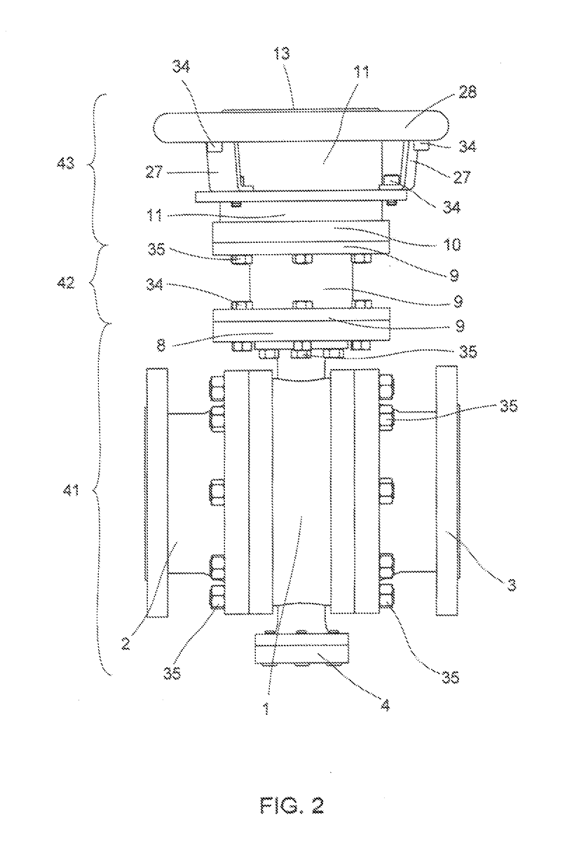

FIG. 1 is a perspective view of the present invention in a fully assembled state. This figure shows the valve body 1, the left flange 2, the right flange 3, and the trunnion cover 4. The left and right flanges 2, 3 are bolted to the valve body 1 and allow the valve to be connected to piping (not shown). The trunnion cover 4 houses the trunnion 7 (not shown). The present invention comprises an adapter plate 8, which is bolted to the bottom enclosure 9, as well as the valve body 1 (see FIG. 2). Note that the adapter plate 8 may also be integral with (i.e., the same part as) the bottom enclosure 9 rather than a separate part. As shown in subsequent figures, the bottom enclosure 9 contains the planetary gear subassemblies 44.

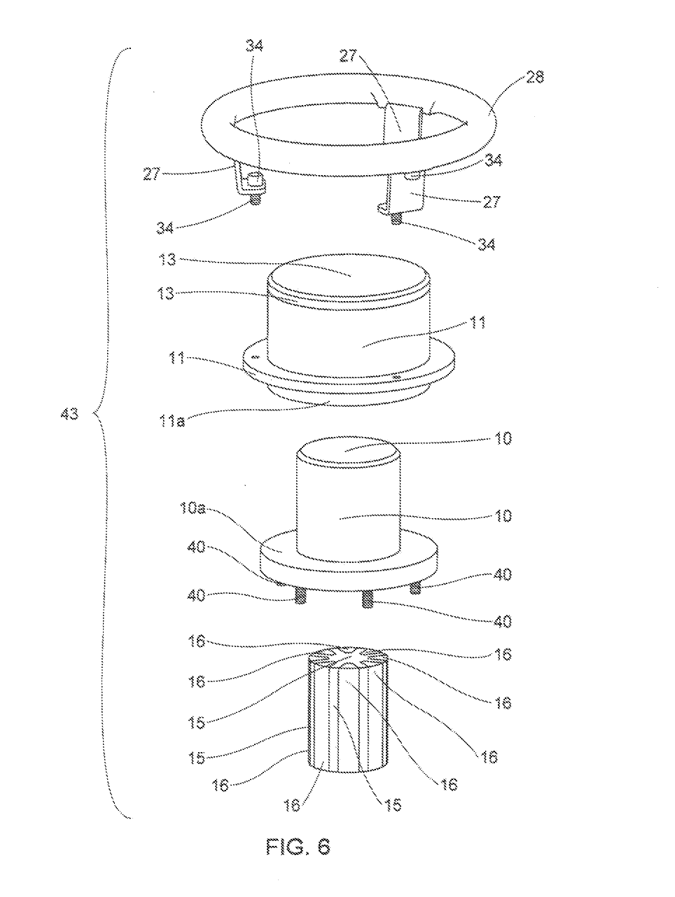

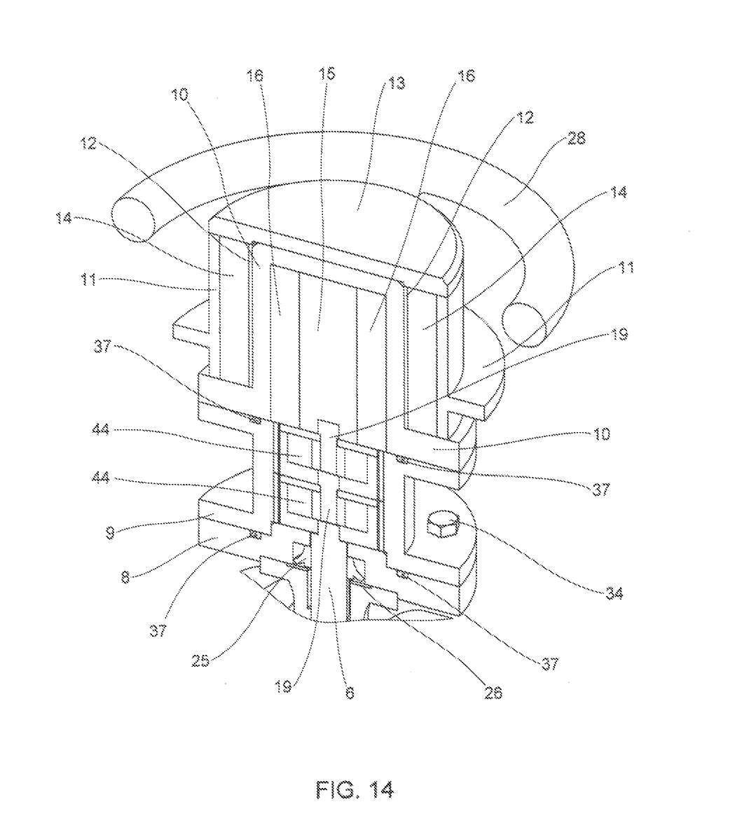

The bottom enclosure 9 in turn is bolted to the top enclosure 10, which contains part of the cylindrical magnet wheel actuator assembly 43 (not shown). In an alternate embodiment, the bottom and top enclosures 9, 10 are a single part. The top enclosure 10 fits inside of the driver housing 11 (see FIGS. 6 and 14), and the bottom part 11a of the driver housing 11 rotates on top of the bottom disc 10a of the top enclosure 10. The driver cap 13 is affixed to the top of the driver housing 11 and seals the top of the driver housing 11 so that no dirt or debris comes into contact with the outer magnets 14 (not shown).

In the embodiment shown in FIG. 1, the valve is actuated by an actuator wheel 28. Actuator spokes 27 connect the actuator wheel 28 to the driver housing 11. Various bolts 34, hex nuts 35 and studs 40, all of which serve to connect various parts together, are also shown in FIG. 1.

FIG. 2 is a side view of the present invention in a fully assembled state. This figure shows the three main assemblies of the present invention: the adapter plate assembly 41, the torque multiplier assembly 42, and the cylindrical magnet wheel actuator assembly 43. These various assemblies will be broken down and discussed in connection with subsequent figures.

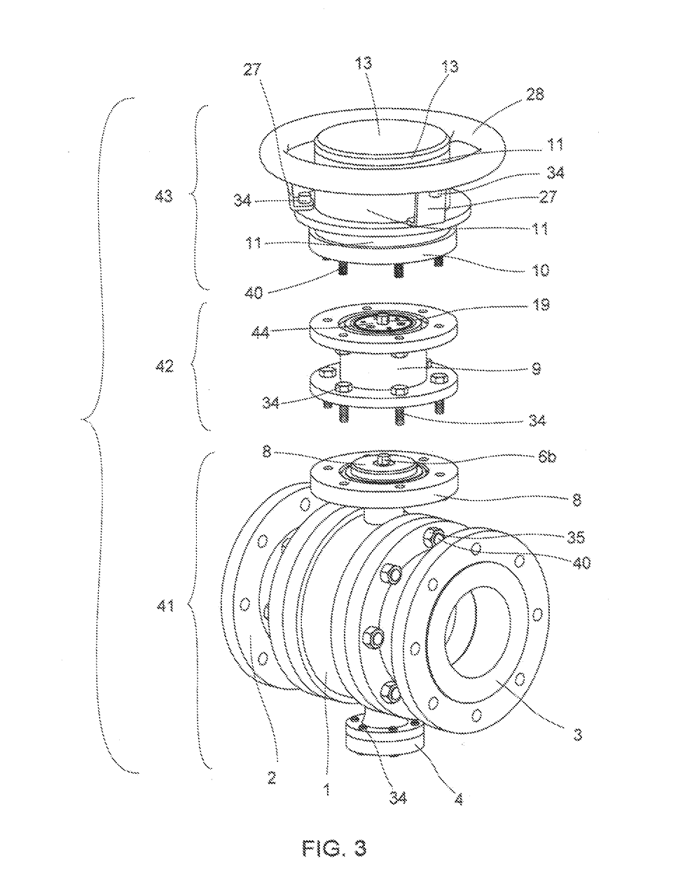

FIG. 3 is an exploded view of the present invention. This figure shows the adapter plate assembly 41, the torque multiplier assembly 42, and the cylindrical magnet wheel actuator assembly 43. As shown in this figure, these three assemblies are bolted together when the invention is fully assembled.

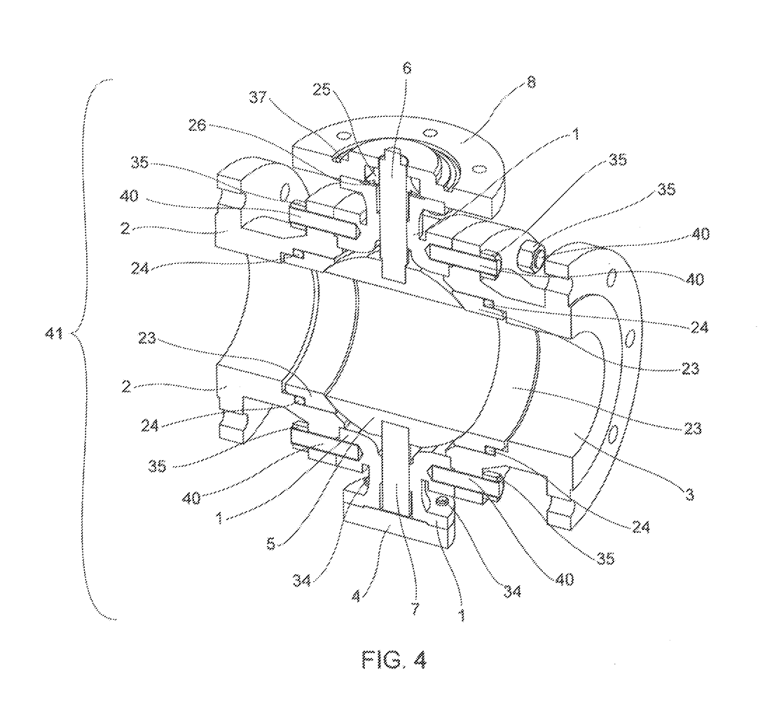

FIG. 4 is a section view of the adapter plate assembly of the present invention. This figure shows the valve body 1, left flange 2, right flange 3 and trunnion cover 4. It also shows the ball 5, shaft 6, trunnion 7 and adapter plate 8. Although this figure is shown with a ball valve 5, as will be explained below, the present invention is designed to work with any type of rotary valve. One end of the shaft 6 extends into the ball 5 and causes the ball to rotate. In a preferred embodiment, the ball 5 rotates about the trunnion 7, which is stationary in the trunnion cover 4. Alternately, the ball 4 and trunnion 7 could rotate together in the trunnion cover 4.

ball seat 23 lies on either side of the ball 5. The purpose of the ball seats 23 is to seal out fluid between the ball 5 and the right and left flanges 2, 3. A rubber spring gasket 24 surrounds each seat 23 and provides a seal between the flanges 2, 3 and the seat 23. The rubber spring gasket 24 also provides positive pressure between the seat 23 and the ball 5. A ring seal 25 surrounds the shaft 6 and is situated between the valve body 1 and the adapter plate 8. The purpose of the ring seal 25 is to prevent fluid from exiting the valve body 1 and coming into contact with the torque multiplier assembly 42 (not shown). The ring seal 25 also acts to equalize pressure between fluid inside of the valve body 1 and fluid inside of the top and bottom enclosures 9, 10. The valve-adapter plate seal 26 provides a static seal between the valve body 1 and the adapter plate 8. An o-ring 37 lies inside of a recess in the adapter plate 8 and acts as a static seal between the adapter plate 8 and the bottom enclosure 9. Bolts 34, hex nuts 35 and studs 40 serve to secure the various parts together.

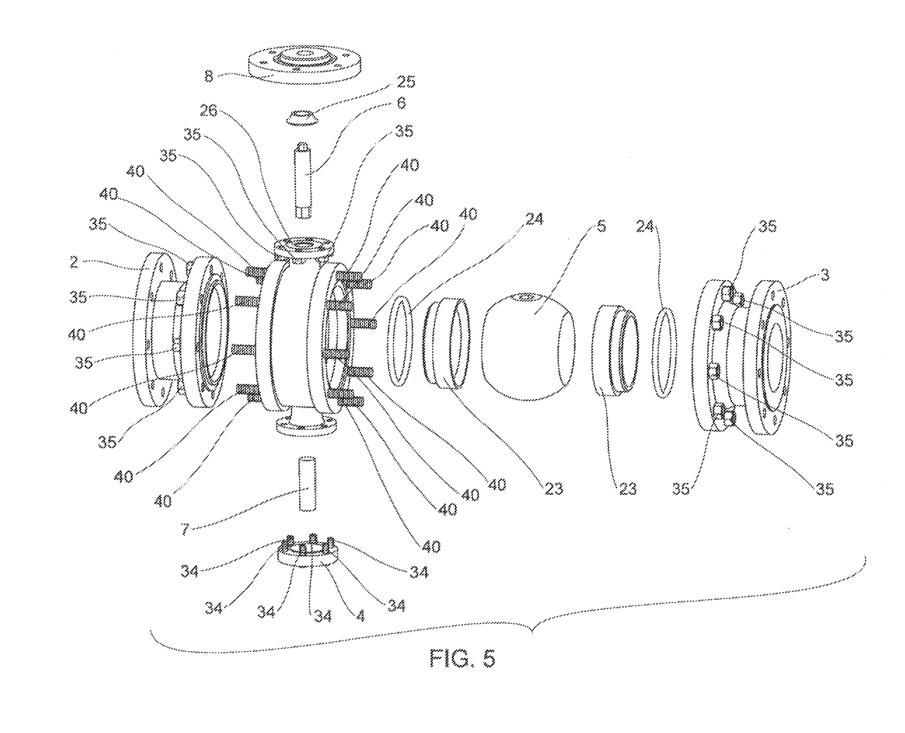

FIG. 5 is an exploded view of the adapter plate assembly of the present invention. The figure shows the same parts as in FIG. 4, namely, the left flange 2, right flange 3, trunnion cover 5, ball 5, shaft 6 and trunnion 7. It also shows the seats 23 on either side of the ball 5, the rubber spring gaskets 24, the ring seal 25, and the valve-adapter plate seal 26. Bolts 34, hex nuts 35 and studs 40 serve to secure the various parts together.

FIG. 6 is an exploded view of the magnetic actuator assembly of the present invention. This figure shows the top enclosure 10, the driver housing 11, and the driver cap 13. It also shows the follower support 15, which carries a plurality of inner magnets 16. The follower support 15 (with inner magnets 16) fits into the top enclosure 10, which in turn fits into the driver housing 11. This figure also shows the actuator spokes 27, which are connected to the actuator wheel 28. When the invention is fully assembled, the actuator spokes 27 are bolted into the driver housing 11 so that when the actuator wheel 28 is turned, the driver housing 11 also rotates. As shown in the next figure, outer magnets 14 are housed within the driver housing 11 and are magnetically coupled with the inner magnets 16 in the follower support 15. The top enclosure 10 acts as a physical barrier between the inner and outer magnets 16, 14 but does not prevent them from being magnetically coupled.

Thus, as the driver housing 11 is rotated by the actuator wheel 28, the magnetic coupling between the outer magnets 14 in the driver housing 11 and the inner magnets 16 in the follower support 15 cause the follower support 15 to rotate at the same rate as the driver housing 11. The top enclosure 10 is bolted to the bottom enclosure 9.

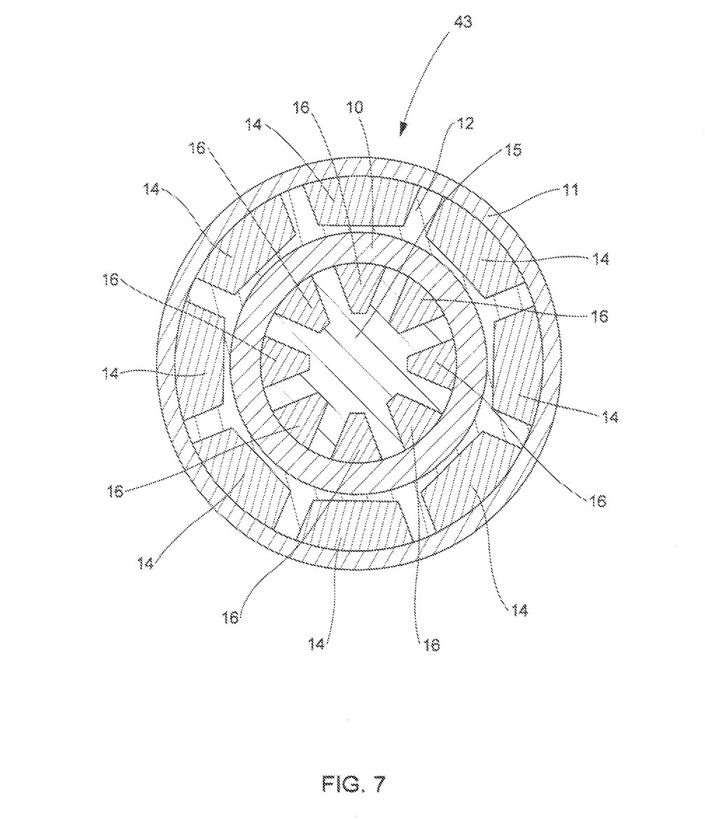

FIG. 7 is a section view of the magnetic actuator assembly of the present invention. This figure shows the top enclosure 10, the driver housing 11, and the driver support 12. The driver housing 11 contains the outer magnets 14 and the driver support 12. FIG. 7 also shows the outer magnets 14, the follower support 15, and the inner magnets 16. This figure shows how the inner magnets 16 are arrayed within the follower support 15 and the outer magnets 14 are arrayed within the driver support 12. It also shows how the top enclosure 10 acts as a physical barrier between the inner 16 and outer 14 magnets and how the driver housing 11 encloses the driver support 12 and outer magnets 14.

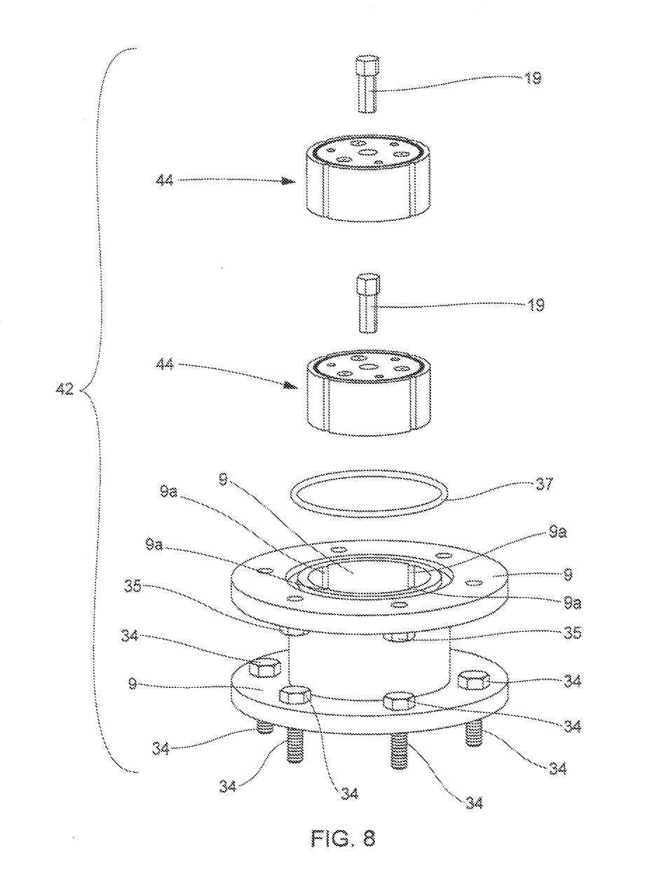

FIG. 8 is an exploded view of the torque multiplier assembly of the present invention. The torque multiplier assembly 42 includes the bottom enclosure 9, which houses the planetary gear subassemblies 44. An o-ring 37 is situated in a recess in the top of the bottom enclosure 9 to provide a static seal between the bottom and top enclosures 9, 10. In this figure, two planetary gear subassemblies 44 are shown, but the present invention is not limited to any particular number of planetary gear subassemblies. In fact, it is contemplated by the inventors that a preferred embodiment could comprise anywhere from one to ten planetary gear subassemblies. The number of planetary gear subassemblies included will depend on the torque and space requirements for the Particular valve application.

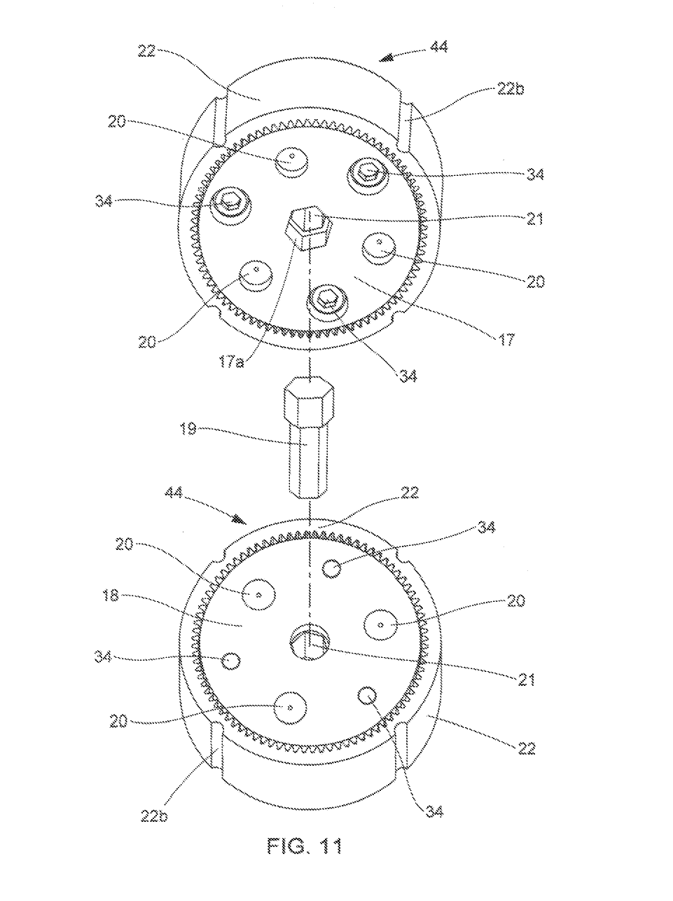

The planetary adapter 19 is inserted into the center of the planetary gear subassembly 44. As shown in FIG. 8, each planetary gear subassembly has a planetary adapter 19. The function of the planetary adapter 19 will be discussed more fully in connection with FIG. 11.

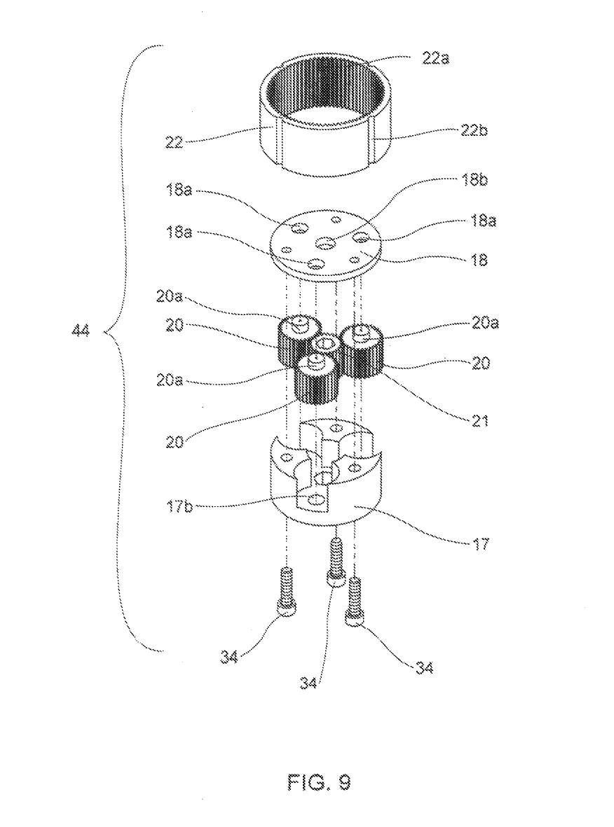

FIG. 9 is an exploded view of the planetary gear subassembly of the torque multiplier assembly of the present invention. As shown in this figure, each planetary gear subassembly 44 is comprised of a sun gear 21, a ring gear 22, and three planetary gears 20. In a preferred embodiment, there are three planetary gears (because they represent the most efficient configuration), but the present invention is not limited to any particular number of planetary gears. The ring gear 22 comprises internal threads 22a and one or more channels 22b on the outside of the ring gear. The planetary gears 20 fit into (i.e., are situated within or on) a carrier 17, which is bolted to a planetary plate 18. Note that the axle 20a of each planetary gear 20 fits into an aperture 18a in the planetary plate 18 and an aperture 17b (only one of three apertures 17b is shown) in the carrier 17.

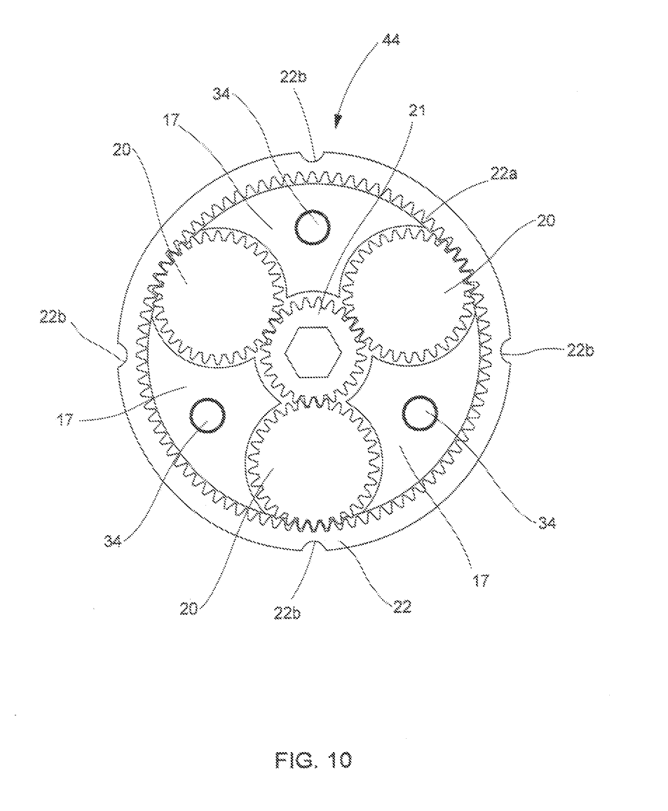

FIG. 10 is a section view of the planetary gear subassembly of the torque multiplier assembly of the present invention. This figure shows a single planetary gear subassembly 44 fully assembled. As shown in this figure, the sun gear 21 is located in the center oldie planetary gear subassembly, and the three planetary gears 20 are situated around and engage with the sun gear 21 so that as the sun gear 21 rotates, the planetary gears 20 also rotate. As the planetary gears 20 rotate, they “walk” around the inside of the ring gear 22, thereby causing the carrier 17 to rotate (see FIG. 9, which shows how the planetary gears 20 fit into the carrier 17). The channels 22b on the outside of the ring gear 22 correspond to ridges 9a in the bottom enclosure 9 (see FIG. 8) such that the ring gear 22 is held in place (i.e., stationary) within the bottom enclosure 9.

FIG. 11 is a detail perspective view of two planetary gear subassemblies and the planetary adapter of the torque multiplier assembly of the present invention. As noted above, in the embodiment shown in the figures, the torque multiplier assembly (see FIG. 8) comprises two planetary gear subassemblies 44 and two planetary adapters 19. The present invention is not limited to any particular number of planetary gear subassemblies, however. As shown in FIG. 11, each planetary gear subassembly 44 comprises a sun gear 21, a ring gear 22, and three planetary gears 20 (see also FIGS. 9 and 10). The ring gear 22 comprises channels 22b that allow the ring gear to fit into the bottom enclosure 9 (see FIG. 8). These channels 22b correspond to ridges 9a in the bottom enclosure 9. In this manner, the ring gear 22 is held stationary inside the bottom enclosure 9.

Bolts 34 secure the carrier 17 to the planetary plate 18 of each planetary gear subassembly 44. One end of the planetary adapter 19 fits into a socket 17a in the carrier 17 of the first planetary gear subassembly 44 such that the planetary adapter 19 rotates with the carrier 17. The other end of the planetary adapter 19 is inserted into the center of the sun gear 21 of the second planetary gear subassembly 44. Both ends of the planetary adapter 19 are preferably hexagon-shaped so that the sun gear 21 will not rotate on the planetary adapter 19 but rather will rotate with it. Thus, the sun gear 21 on the second (in FIG. 11, the lower) planetary gear subassembly 20 rotates at the same speed as the planetary adapter 19, which rotates at the same speed as the carrier 17 in the first planetary gear subassembly 20. Note that the aperture 18b in the center of the planetary plate 18 is not hex-shaped but round, which allows the planetary plate 18 to rotate about the planetary adapter 19.

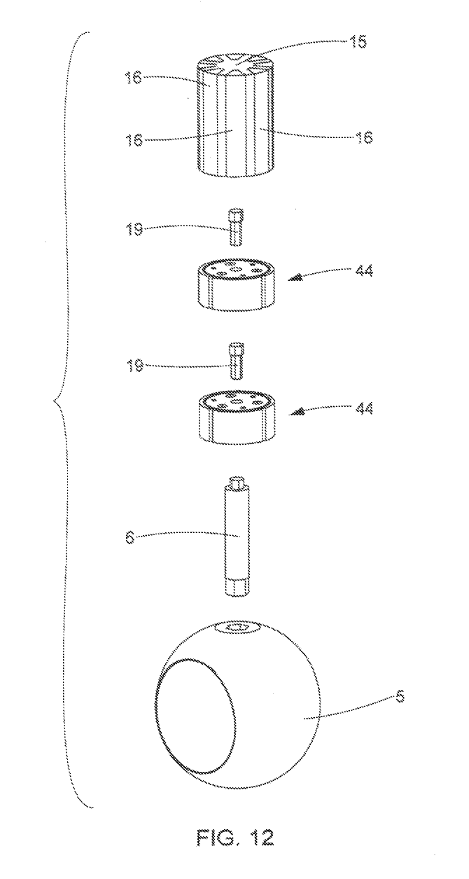

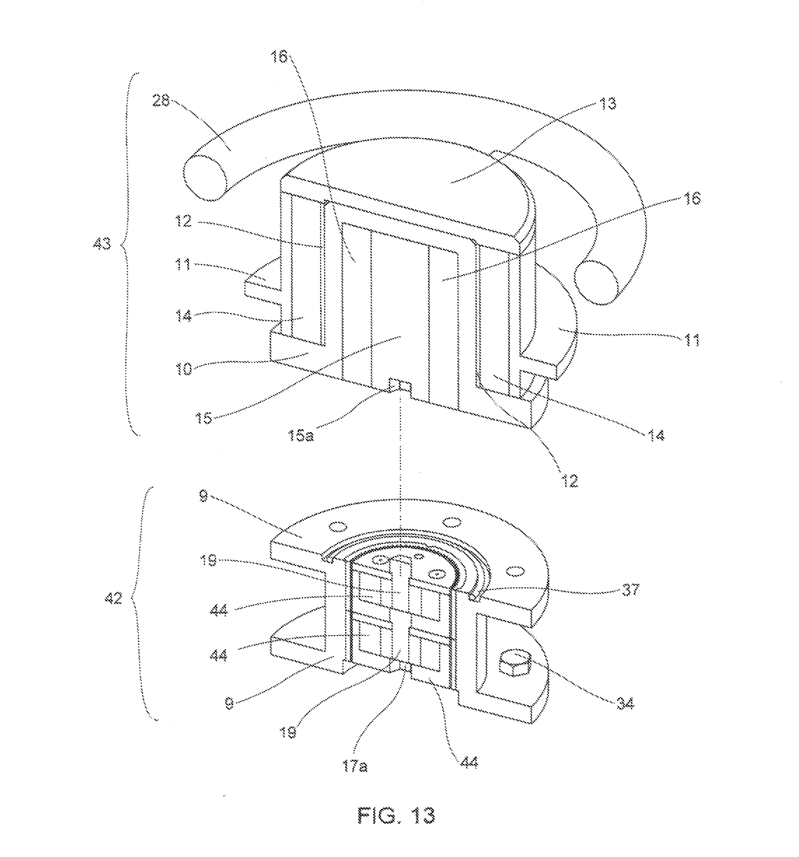

FIG. 12 is a perspective view of the inner magnets, follower support, planetary adapters, planetary gear subassembly, shaft, and ball of the present invention. As shown in this figure, there is a planetary adapter 19 located between the follower support 15, which houses the inner magnets 16, and the first planetary gear subassembly 44. One end of this planetary adapter 19 fits into a socket 15a (see FIG. 13) in the follower support 15 such that the planetary adapter 19 rotates with the follower support 15. The second end of this planetary adapter 19 is inserted into the center of the sun gear 21 (not shown) of the first planetary gear subassembly 44 and causes the sun gear 21 of the first planetary gear subassembly 44 to rotate at the same speed as the follower support 15.

One end of the shaft 6 is inserted into the carrier 17 (not shown) on the second (lower in FIG. 12) planetary gear subassembly 44 such that the shaft 6 rotates at the same speed as the carrier 17. The other end of the shaft 6 is inserted into the ball 5, thereby causing the ball to rotate with the carrier 17 of the planetary gear subassembly 44 that is physically most proximate (closest) to the ball 5 (i.e., the last planetary gear subassembly 44 in the series of planetary gear subassemblies of the torque multiplier assembly 42).

Due to the magnetic interlock between the outer and inner magnets 14, 16, the follower support 15 and inner magnets 16 rotate at the same speed as the driver housing 11, driver support 12, driver cap 13 and outer magnets 14, all of which rotate at the same speed as the wheel actuator 28. The first planetary adapter 19 rotates at the same speed as the follower support 15. The planetary adapter 19 in turn causes the sun gear 21 of the first planetary gear subassembly 44 to rotate at the same speed as the planetary adapter 19. As noted above, rotation of the sun gear 21 causes the planetary gears 20 to rotate around the inside of the ring gear 22. The planetary gears 20 rotate about the sun gear 21 at a speed that is slower than the speed at which the sun gear 21 rotates. This speed reduction is based on the ratio between the size of the sun gear 21 and the size of the ring gear 22 (or, in other words, on the size of the planetary gears 20 in relation to the sun gear 21 because they span the distance between the sun gear 21 and the ring gear 22). Torque is increased with the transfer of energy between the sun gear 21 and the planetary gears 20.

The ring gear 22 does not rotate; however, the carrier 17 rotates at the same speed at which the planetary gears 20 rotate about the sun gear 21. Thus, the carrier 17 rotates at a speed slow than that of the sun gear 21. The planetary adapter 19 between the first and second planetary gear subassemblies 44 rotates at the same speed as the carrier 17 of the first planetary gear subassembly 44 and causes the sun gear 21 of the second planetary gear subassembly 44 to rotate at this same rate. (The sun gear 21 of the second planetary gear subassembly 44 rotates more slowly than the sun gear 21 of the first planetary gear subassembly 44 due to the speed reduction provided by the planetary gears 20 of the first planetary gear subassembly 44. This is true for each planetary gear subassembly 44 in the torque multiplier assembly 42.) In turn, the planetary gears 20 of the second planetary gear subassembly 44 cause the carrier 17 on the second planetary gear subassembly 44 to rotate at a speed that is slower than that of the planetary adapter 19 between the two planetary gear subassemblies 44 (and slower than that of the carrier 17 on the first planetary gear subassembly).

As explained above, the torque increases with the transfer of energy from the sun gear 21 to the planetary gears 20 of the second planetary gear subassembly 44. In a preferred embodiment, the torque multiplier for each planetary gear subassembly is roughly 3.5:1. With two planetary gear subassemblies, the torque multiplier from the wheel actuator 28 to the ball 5 is roughly 12.25 (i.e. 3.5 times 3.5). The speed reduction is equal to the increase in torque; for example, if the torque increase is 12.25, then the speed reduction is also 12.25.

FIG. 13 is a section view of the actuator assembly and torque multiplier assembly of the present invention. The actuator wheel 28 is connected via actuator spokes 27 (not shown) to the driver housing 11, which contains the driver support 12, which in turn houses the outer magnets 14 (see FIG. 7). The top enclosure 10 is situated between the outer and inner magnets 14, 16. The planetary adapter 19 of the first planetary gear subassembly 44 fits into a socket 15a in the follower support 15. The lower half of FIG. 13 shows the two planetary gear subassemblies 44 installed into the bottom enclosure 9. It also shows how the two planetary adapters 19 are linearly aligned with one another. The shaft 6 (not shown) is inserted into the socket 17a in the carrier 17 of the second planetary gear subassembly 44.

As used herein, the term “first planetary gear subassembly” refers to the planetary gear subassembly that interfaces directly (via the planetary adapter 19) with the follower support, and the term “second planetary gear subassembly” refers to the planetary gear subassembly that interfaces directly via the shaft) with the ball 5, here may be any number of planetary gear subassemblies, and each would interface with the other in the manner shown in FIG. 13 (i.e., via a planetary adapter 19, one end of which is inserted into the carrier of the previous planetary gear subassembly and the other end of which is inserted into the sun gear of the next planetary gear subassembly). As claimed in claim 1, the rotation of the carrier in the first planetary gear subassembly causes the sun gear of the second planetary gear subassembly to rotate—either directly via the planetary adapter between the first and second planetary gear subassemblies or indirectly via the other planetary gear subassemblies and their planetary adapters—regardless of how many other planetary gear subassemblies there are between the first and second planetary gear subassemblies or whether there are none at all.

FIG. 14 is a cropped section view of the present invention in a fully assembled state. All of the parts shown in this figure have been mentioned and/or described in connection with previous figures.

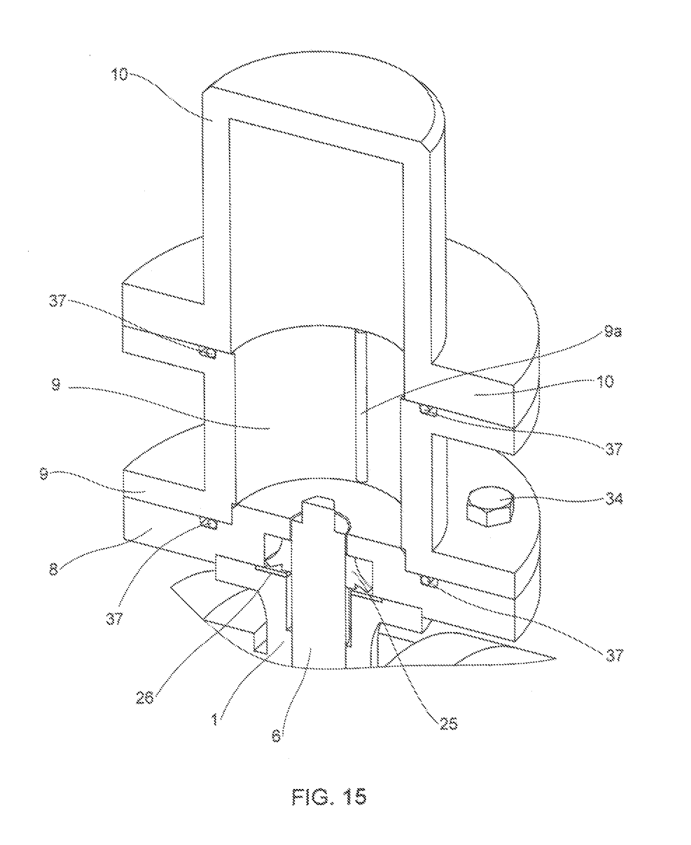

FIG. 15 is a detail perspective view of the top enclosure, bottom enclosure, o-rings, valve body, ring seal, valve-adapter plate seal, shaft, and adapter plate of the present invention. All of the parts shown in this figure have been mentioned and/or described in connection with previous figures. This figure clearly shows the ridges 9a in the bottom enclosure 9 that hold the ring gear 22 in place (the ridges 9a fit into the channels 22b in the ring gear 22). It also shows the end of the shaft 6 that fits into the carrier 17 on the second planetary gear subassembly 44 (not shown). This figure provides a detail view of the ring seal 25 and adapter-plate seal 26. Because the shaft 6 is rotating, the ring seal 25 is a dynamic seal; however, it is also fully enclosed because the top and bottom enclosures 9, 10 prevent any emissions from escaping to the outside environment. The ring seal 25 is the only dynamic seal in the present invention.

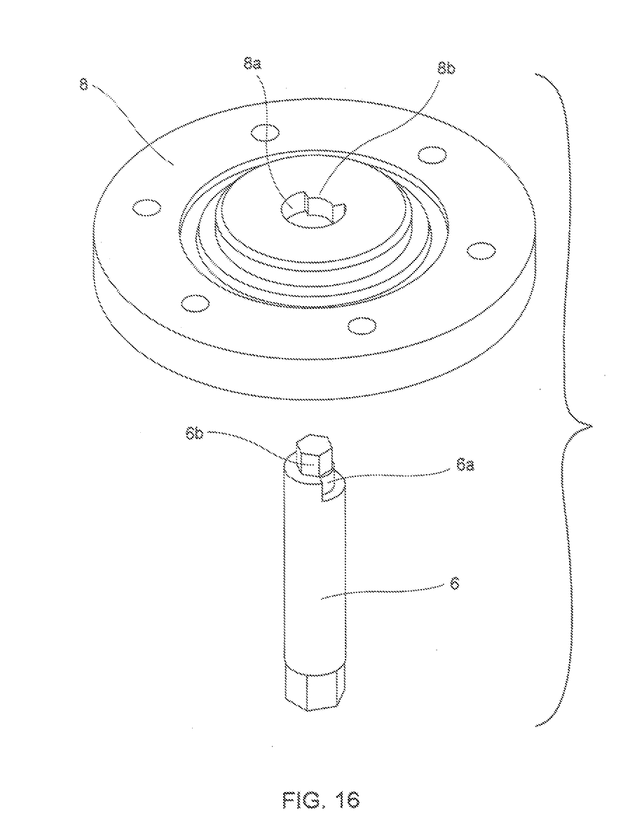

FIG. 16 is a perspective view of the shaft with a positive stop and adapter plate with a positive stop. As shown in this figure, the adapter plate 8 has a cutout 8a in the center of the adapter plate 8 through which the shaft 6 is inserted (see also FIG. 15). In a preferred embodiment, this cutout 8a comprises a protrusion 8b that interacts with a recess 6a on one end of the shaft 6. This interaction between the shaft recess 6a and adapter plate protrusion 8b ensures that the ball 5 (not shown) will not rotate more than ninety (90) degrees. The driver 6b on the same end of the shaft 6 as the recess 6a extends into the carrier 17 of the second planetary gear subassembly 44 (see FIG. 14).

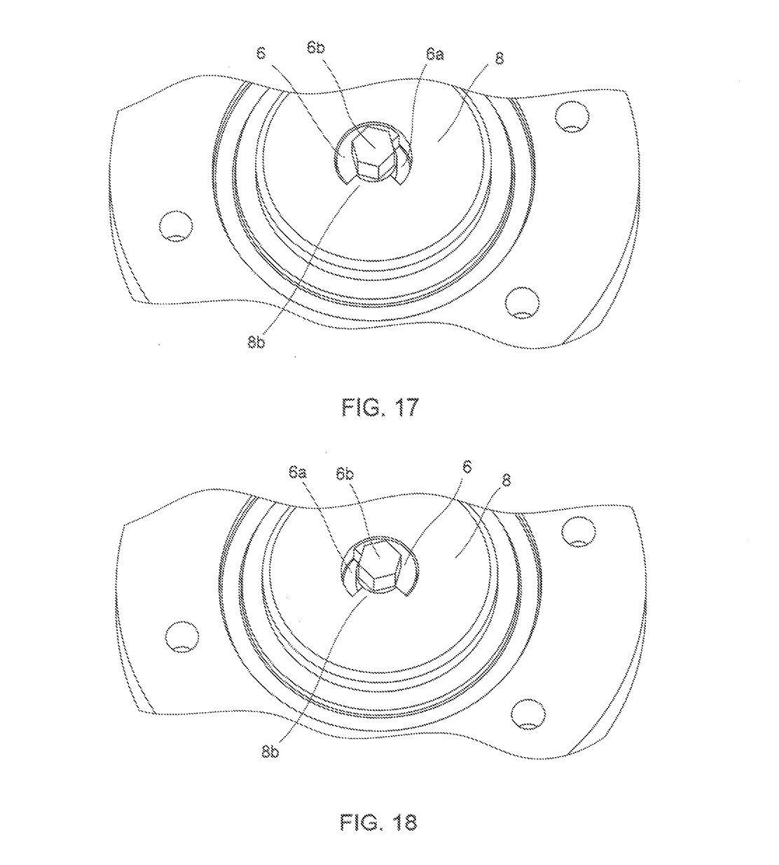

FIG. 17 is a detail perspective view of the shaft with a positive stop and adapter plate with a positive stop with the valve in an open position. FIG. 18 is a detail perspective view of the shaft with a positive stop and adapter plate with a positive stop with the valve in a closed position. These two figures show the positive stop (i.e. the shaft recess 6a and adapter plate protrusion 8a) in operation.

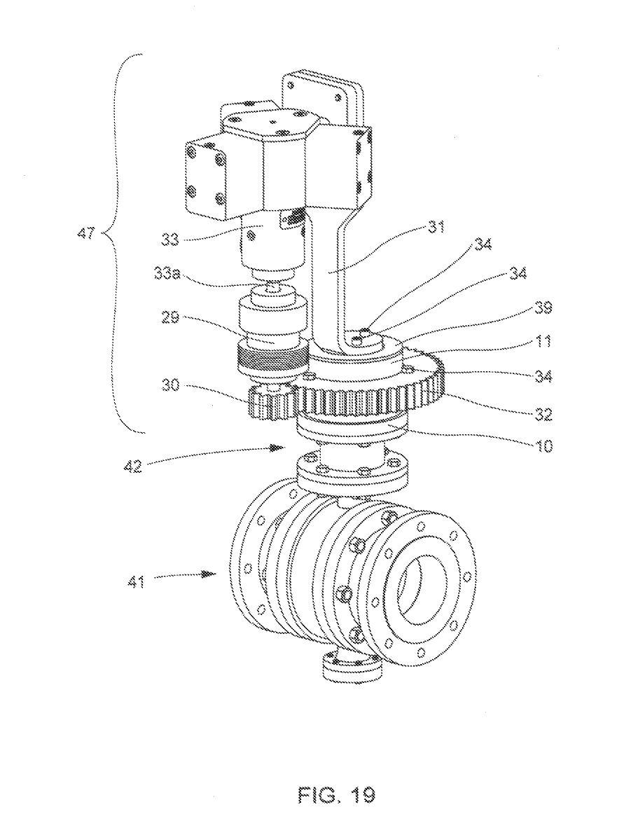

FIG. 19 is a perspective view of the present invention shown with a motor actuator assembly. In this embodiment, the actuator wheel 28 is replaced with a cylindrical magnet motor actuator assembly 47 comprising a clutch 29, a motor gear 30, a motor mounting bracket 31, a motor ring gear 32, and a motor 33. The purpose of the clutch 29 is to conditionally attach the motor 33 to the motor gear 30. The purpose of the motor mounting bracket 31 is to secure the motor 33 to the to top enclosure 10 and to ensure proper positioning of the motor gear 30 in relation to the motor ring gear 32. The motor 33 turns the motor gear 30, which engages with the motor ring gear 32, causing it to rotate.

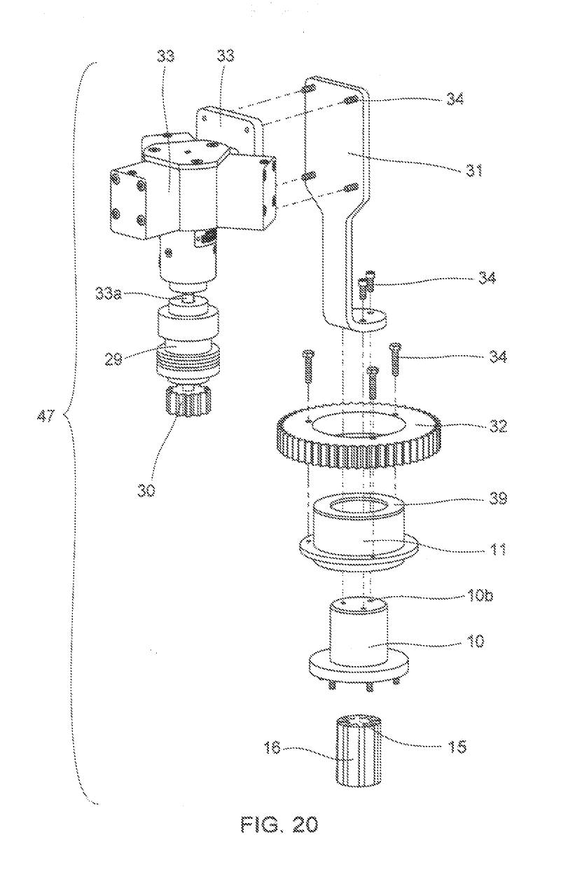

FIG. 20 is an exploded view of the motor actuator assembly of the present invention. As shown in this figure, the motor ring gear 32 is preferably bolted to the bottom part 11a of the driver housing 11: The magnetic coupling between the outer magnets 14 (not shown but located inside of the driver housing 11) and the inner magnets 16 (not shown but located inside the top enclosure 10) is the same as described above. In this embodiment, the ring gear 32 causes the driver housing 11 (and, therefore, the outer magnets 14) to rotate. The driver cap 39 is specialized in form (namely, it has a relatively large hole in the center) to allow the motor mounting bracket 31 to be bolted directly to the top enclosure 10, as shown in FIGS. 19 and 20.

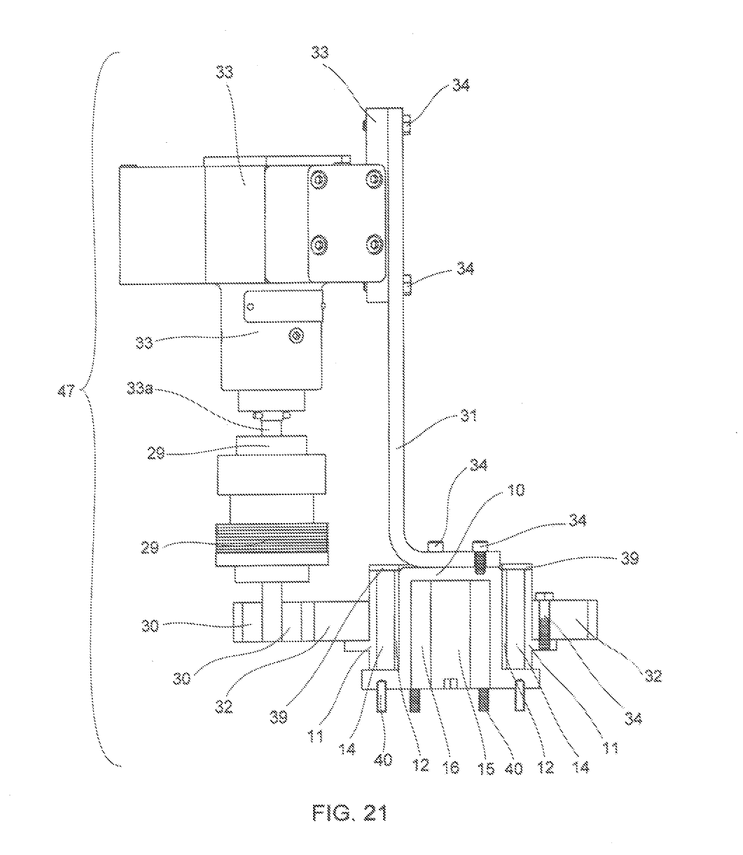

FIG. 21 is a section view of the motor actuator assembly of the present invention. Note that the bolts 34 securing the motor bracket 31 to the top enclosure 10 do not penetrate through to the interior of the top enclosure 10. The purpose of the top enclosure 10 is to contain any emissions from the dynamic seal at the shaft 6 (described above); therefore, puncturing the top enclosure 10 is something that should be avoided.

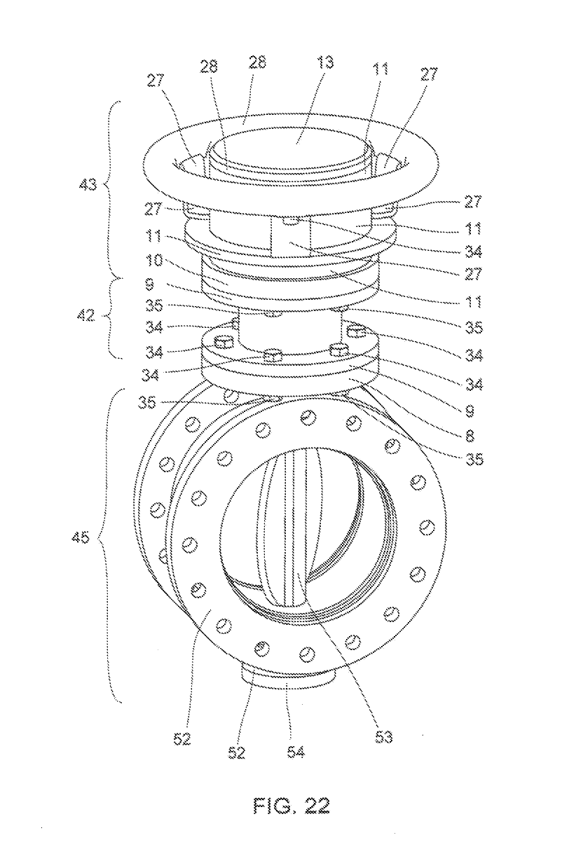

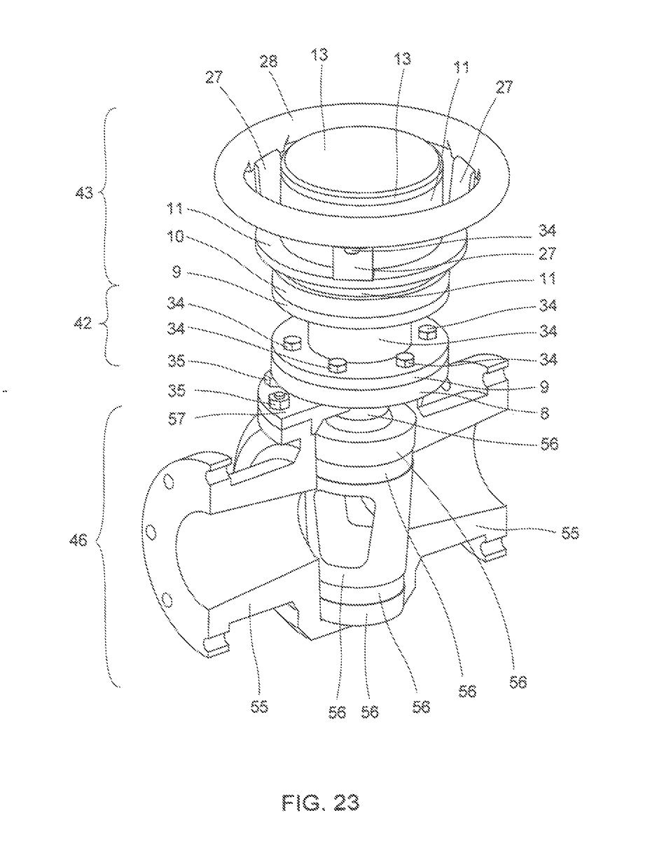

FIG. 22 is a perspective view of the present invention shown attached to a butterfly valve, and FIG. 23 is a perspective cut-away view of the present invention shown attached to a plug valve. The embodiments previously described are all shown with a ball valve; however, the present invention may be used with any kind of rotary valve, as noted above. In FIG. 22, the present invention is shown with a butterfly valve assembly 45. The butterfly valve assembly comprises a butterfly valve body 52, a butterfly disc 53, and a butterfly valve cover 54. In FIG. 23, the present invention is shown with a plug valve assembly 46. The plug valve assembly 46 comprises a plug valve body 55, a plug 56, and a plug valve cover 57. The present invention is not limited to any particular type of rotary valve.

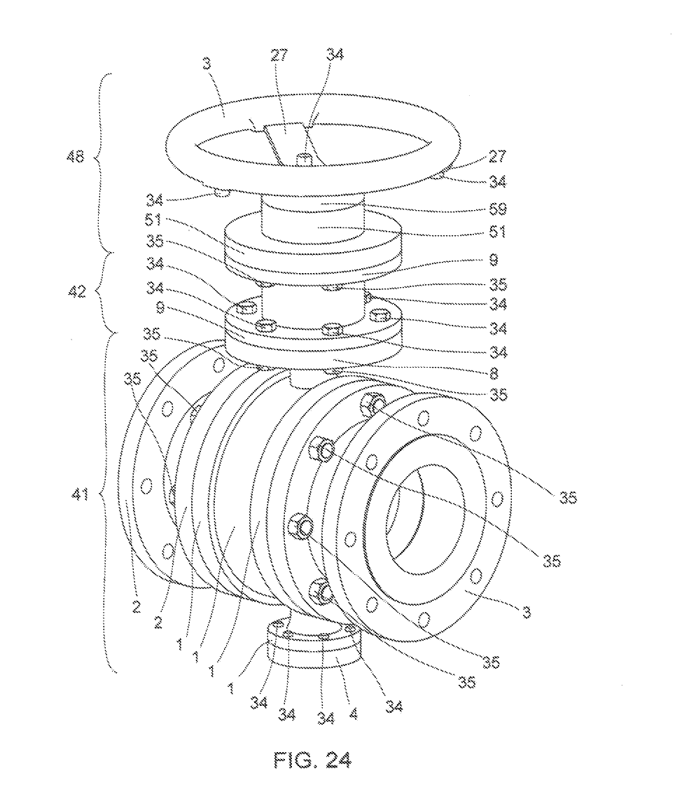

FIGS. 24-27 illustrate an alternate embodiment of the present invention with a different magnetic configuration than the embodiments previously shown. These figures show the radial magnet wheel actuator assembly 48. In this embodiment, rather than the inner magnets 16 being contained within a follower support 15 that fits into a top enclosure 10, which in turn fits into a driver housing 11 that houses a driver support 12 containing the outer magnets 14 (i.e., the array of inner magnets is basically located inside of the array of outer magnets), radial driver magnets 49 held by a radial driver magnet support 58 and radial follower magnets 50 held by a radial follower magnet support 60 are stacked (i.e., arranged linearly within the top enclosure 51) with a portion of the top enclosure 51 between them.

FIG. 24 is a perspective view of the present invention shown with a radial magnet actuation system. In this embodiment, the radial driver magnet cap 59 replaces the driver cap 13 of the previous embodiment. In addition, the top enclosure 51 replaces the top enclosure 10 previously shown.

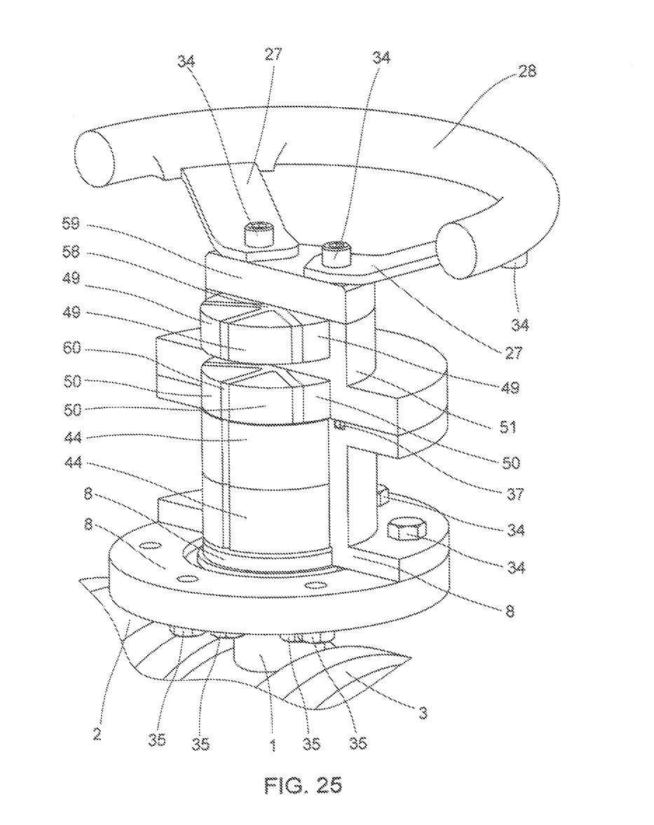

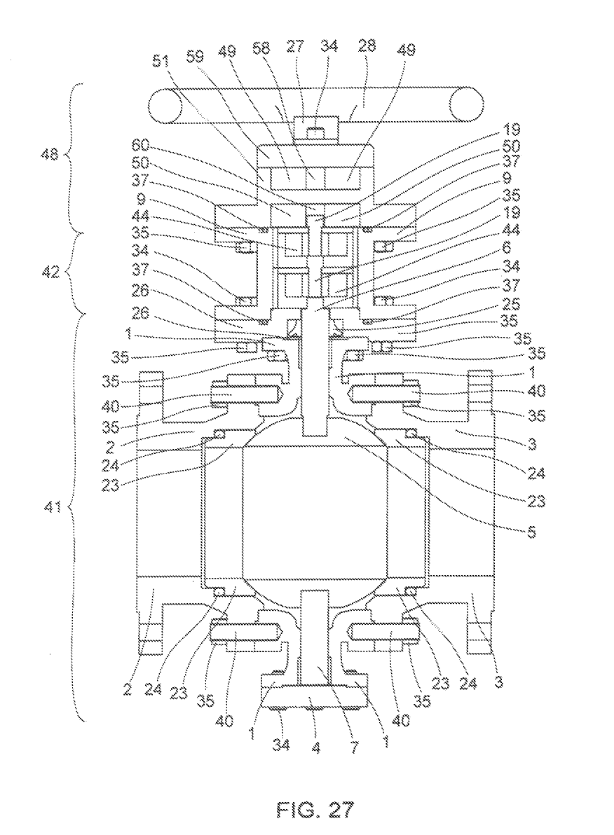

FIG. 25 is a perspective cut-away view of the radial magnet actuation system. As shown in this figure, the radial driver magnets 49 are contained within a radial driver magnet support 58. The radial driver magnet support 58 is inserted into the top part of the top enclosure 51. (Note that this top enclosure 51 is shaped differently than the top enclosure 10 described in connection with previous embodiments.) The radial follower magnets 50 are contained within a radial follower magnet support 60. The radial follower magnet support 60 is inserted into the bottom part of the top enclosure 51; however, part of the top enclosure 51 provides a physical barrier between the inner and outer radial magnets 49, 50 (see FIG. 27).

With this embodiment, the wheel actuator 28 is attached to the radial driver magnet cap 59 by the actuator spokes 27. As the wheel actuator 28 is turned, the radial driver magnet cap 59 rotates, causing the radial driver magnets 49 in the radial driver magnet support 58 to rotate as well. Due to the magnetic coupling between the radial driver magnets and the radial follower magnets, the radial follower magnet support 60 rotates as well. One end of the planetary adapter 19 extending from the first planetary gear subassembly 44 is inserted into a socket (not shown) in the radial follower magnet support 60, and the other end of the planetary adapter 19 is inserted into the sun gear 21 (not shown) of the first planetary gear subassembly (see FIG. 27). In this manner, as the radial follower magnet support 60 rotates, so does the sun gear 21 of the first planetary gear subassembly 44. All other aspects of the invention are as previously described.

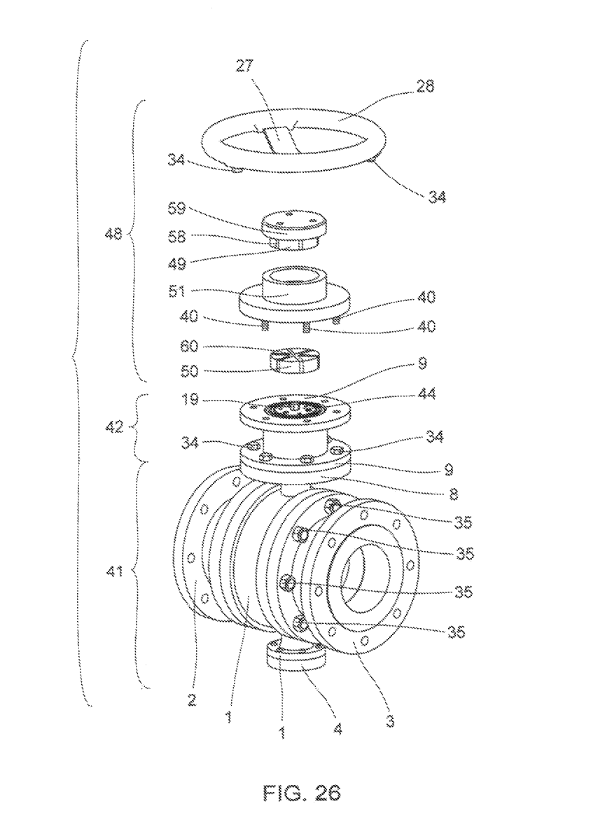

FIG. 26 is an exploded view of the present invention shown with a radial magnet actuation system. As shown in this figure, the top enclosure 51 is bolted to the bottom enclosure 9. The top and bottom enclosures 51, 9 are stationary. The wheel actuator 28, actuator spokes 27, radial driver magnet cap 59, radial driver magnet support 58, radial driver magnets 49, radial follower magnet support 60, and radial follower magnets 50 are the only parts that rotate within the actuator assembly. FIG. 27 is a section view of the present invention shown with a radial magnet actuation system.

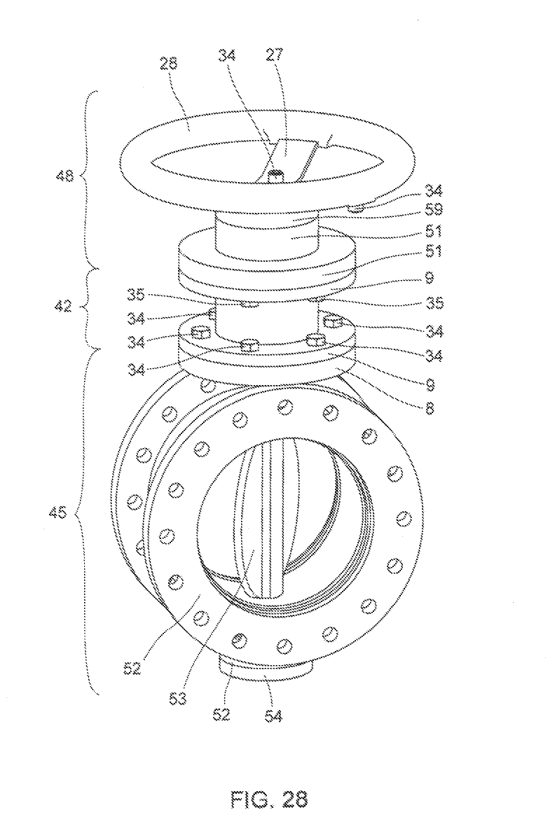

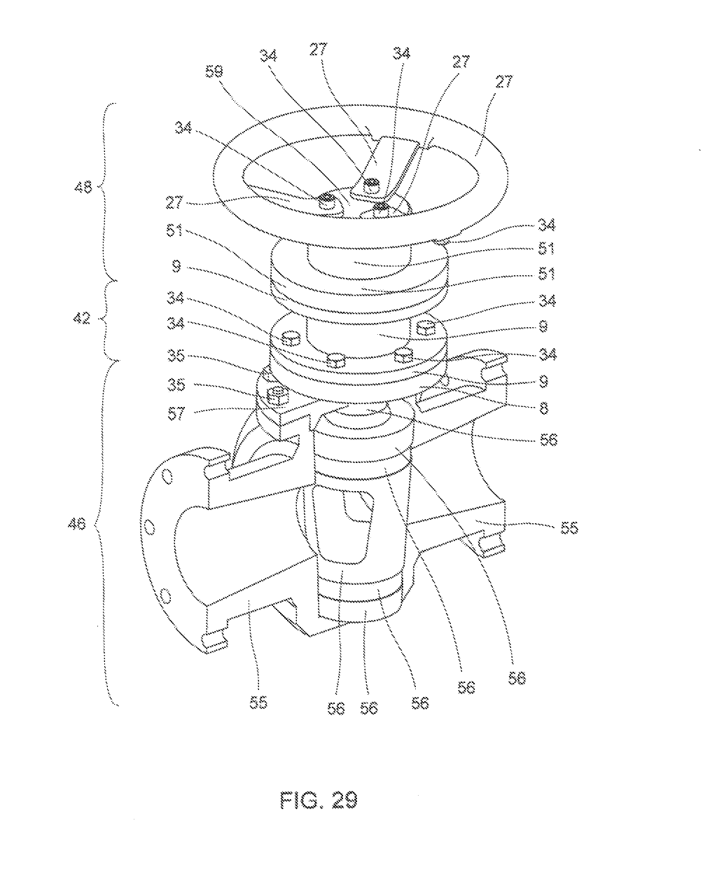

FIG. 28 is a perspective view of the present invention, with the radial magnet actuation system described above, shown attached to a butterfly valve. FIG. 29 is a perspective cut-away view of the present invention, with the radial magnet actuation system described above, shown attached to a plug valve. As stated above, any of the embodiments of the present invention may be used with any type of rotary valve.

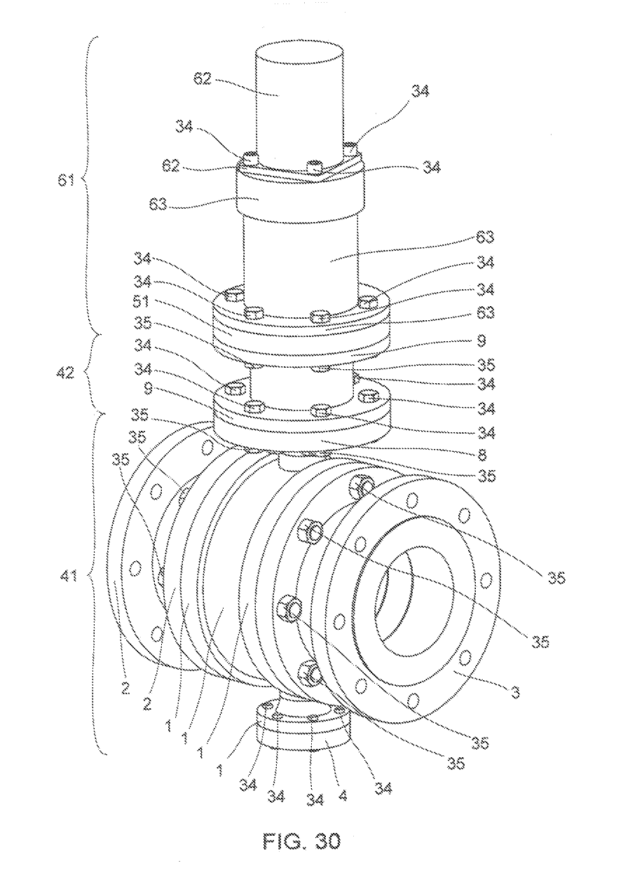

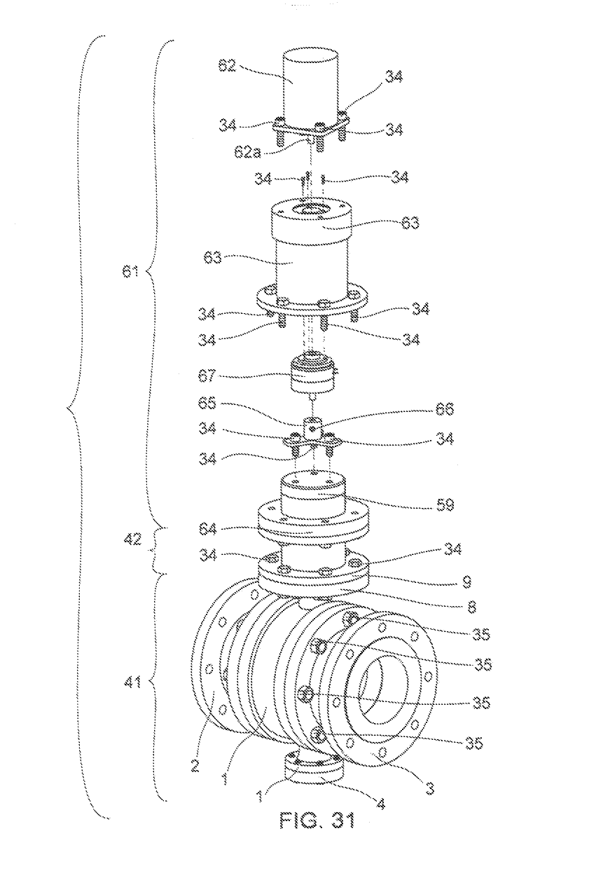

FIGS. 30 and 31 show the radial magnet actuation system with a motor actuator assembly. The radial magnet motor actuator assembly 61 shown in FIGS. 30 and 31 is different than the cylindrical magnet motor actuator assembly 47 shown in FIGS. 19-21 because it has been specifically designed to work with the radial magnets. In FIGS. 30 and 31, the motor drive shaft 62a is connected to the radial driver magnets 49 conditionally through the clutch 67. In FIGS. 19-21, on the other hand, the motor drive shaft 33a is connected to the outer magnets 14 through the clutch 39 and a set of gears 30, 32. In FIGS. 30 and 31, the motor 62 is attached to the clutch 67 with bolts 34, and the clutch 67 is attached to the motor coupler 65 by a set screw 66. The motor coupler 65 is attached to the radial driver magnet cap 59 by bolts 34. Because the radial driver magnets 49 are contained within the top enclosure 64, which is bolted to the radial driver magnet cap 59, they rotate at the same speed as the motor 62. The motor enclosure 63 ensures that the motor is protected from dirt and debris, etc., and it also provides a mounting point for the motor and clutch.

The embodiment shown in FIGS. 30 and 31—namely, the radial magnet actuation system coupled with the motor actuator assembly—is a preferred embodiment because the motor is coupled directly to the radial driver magnets, thereby eliminating the need for the type of ring gear 32 shown in FIG. 20. The latter embodiment is more costly because it entails an extra set of gears on the outside of the actuator; in addition, because the ring gear 32 is exposed to the outside environment, it needs to be protected in some manner from corrosion, dust and debris (this consideration is not present in the embodiment shown in FIGS. 30 and 31).

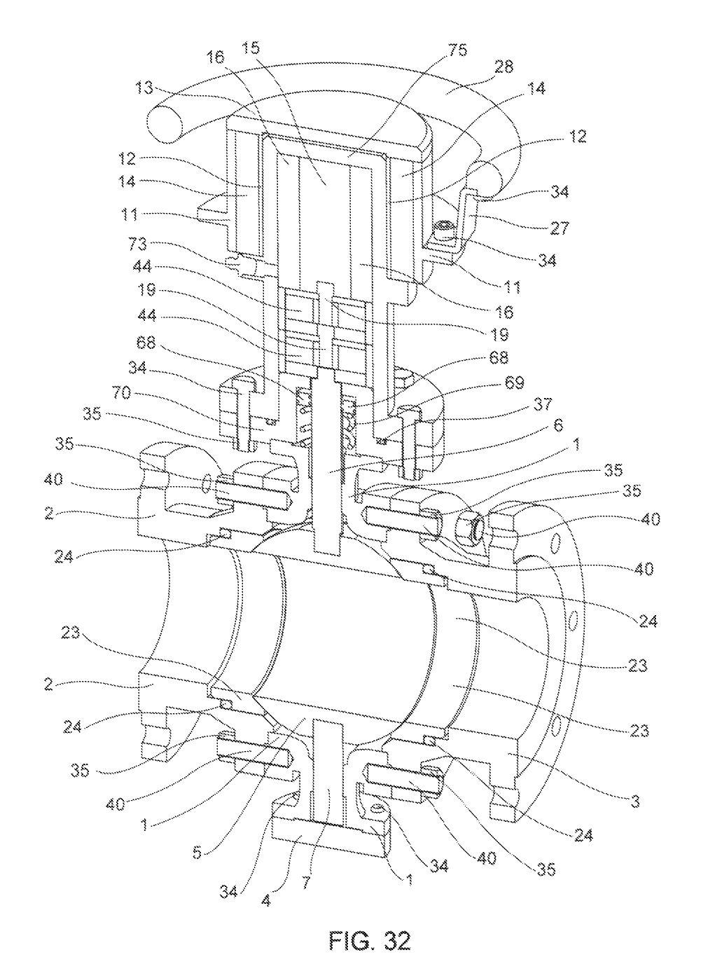

FIG. 32 is a section view of an alternate embodiment of the present invention comprising a pressure equalization system. In this embodiment, the adapter plate 70 is extended longitudinally to accommodate a piston 68 and piston spring 69 inside of the adapter plate 70. The top and bottom enclosures 9, 10 shown in previous embodiments have been combined into a single enclosure 75 to reduce weight and eliminate the need to provide a seal between the top and bottom enclosures; however, the pressure equalization system shown in this figure could also be used with separate top and bottom enclosures. The enclosure 75 comprises a grease fitting 73 through which grease is injected for lubrication purposes.

When the valve is in use, fluid will be flowing through the valve body 1, and the piston 68 acts as an internal dynamic seal between fluid in the valve body 1 and fluid in the enclosure 75. The piston 68 is preferably located between the torque multiplier assembly 42 (not labeled in this figure) and the valve body 1 so that only clean fluid (i.e., fluid injected via the grease fitting 73) comes into contact with the planetary gear subassemblies 44 of the torque multiplier assembly.

The piston 68 surrounds the shaft 6 and is allowed to move longitudinally along the length of the shaft so that as fluid pressure in the enclosure 75 increases, the piston 68 moves closer to the valve body 1, thereby compressing the piston spring 69. Conversely, as fluid pressure in the enclosure 75 decreases and the force of the compressed piston spring 69 overcomes the pressure of the fluid in the enclosure 75 against the piston 68, the piston moves in the opposition direction away from the valve body (i.e., along the shaft in the direction of the planetary gear subassemblies 44). In this manner, the piston 68 is allowed to “float” between the valve body 1 and the top (or ceiling) of the adapter plate 70, thereby acting as a pressure equalizer between the fluid in the valve body 1 and the fluid in the enclosure 75.

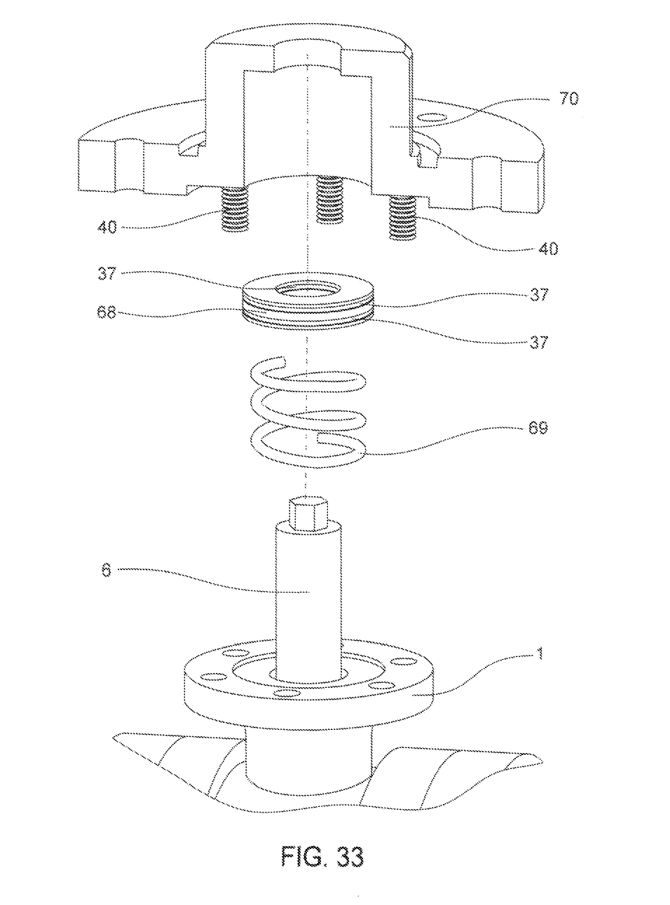

FIG. 33 is an exploded view of the pressure equalization system of the present invention. As shown in this figure, the adapter plate 70 bolts to the valve body 1. The shaft 6 is attached to the ball 5 (not shown) and extends through the valve body 1 and adapter plate 70 and into the carrier 17 of the planetary gear subassembly 44 closest to the shaft (see FIGS. 12, 14 and 15). As described above, the piston spring 69 surrounds the shaft 6 and is situated between the piston 68 and the valve body 1. The piston 68 is preferably shaped like a disc With an aperture in the center for the shaft 6.

Two O-rings 37 fit into recesses in the perimeter of the piston 38, as shown. In a preferred embodiment, the piston spring 69 is engineered so as to ensure that the fluid pressure is always higher on the clean side (i.e., in the enclosure 75) than on the dirty side (i.e. in the valve body 1). Ideally, the piston 68 will prevent any leakage of fluid from the enclosure 75 into the valve body 1 and vice versa; however, the fact that the piston spring 69 maintains a higher fluid pressure in the enclosure 75 than in the valve body 1 ensures that if there ever is any leakage, it will occur from the enclosure 75 into the valve body 1 (clean oil into dirty oil) and not vice versa. The goal is to prevent any dirty oil (that is, oil from the flow path) from coming into contact with the planetary gear subassemblies 44 and to keep the piston seals (O-rings 37) covered in clean oil, which will increase the life of the seals and decrease service costs.

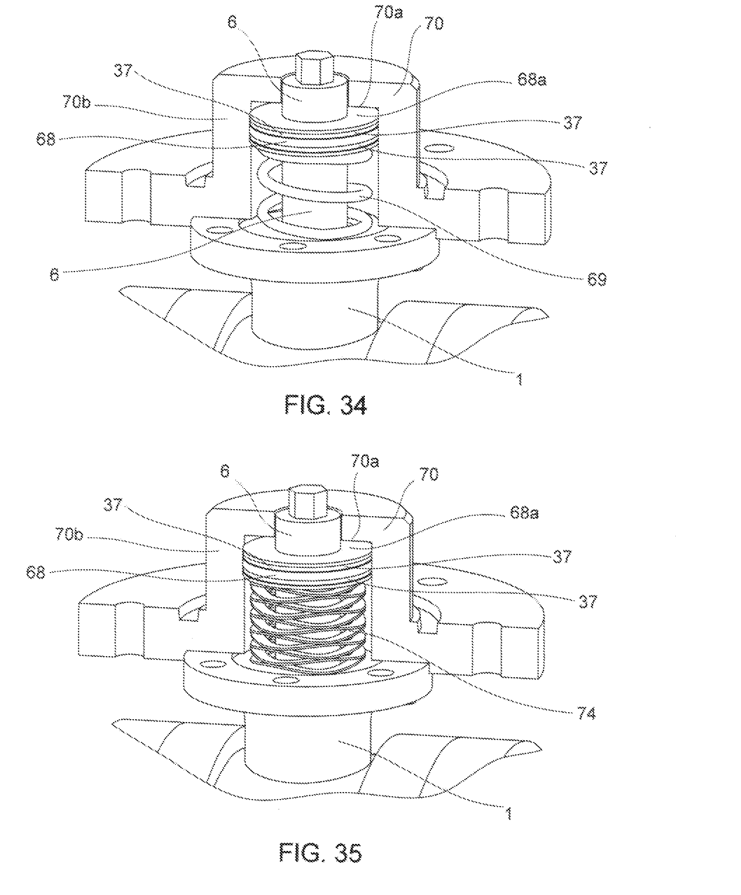

FIG. 34 is a perspective cut-away view of the pressure equalization system of the present invention. This figure shows the same components as in FIG. 33 but fully assembled.

FIG. 35 is a perspective cut-away view of an alternate embodiment of the pressure equalization system comprising a spring washer stack. In this embodiment, the piston spring 69 is replaced with a spring washer stack 74 (i.e., stack of spring washers) that functions similarly to the piston spring 69 by biasing the piston 68 in the direction of the adapter plate ceiling 70a. Just as with the piston example, as fluid pressure in the enclosure 75 increases, thereby applying pressure to the top face 68a of the piston, the piston 68 moves toward the valve body 1 and compresses the spring washer stack 74. When the pressure in the compressed spring washer stack 74 overcomes the fluid pressure on the top face 68a of the piston, then the spring washer stack 74 pushes the piston 68 back toward the ceiling 70a of the adapter plate. In this manner, the piston 68 and spring washer stack 74 act as a pressure equalization system, just as the piston 68 and piston spring 69 shown in FIG. 34 do.

Although a piston spring 69 and spring washer stack 74 are shown as two examples of mechanisms for biasing the piston 68 toward the adapter plate ceiling 70A, the present invention is not limited to any particular biasing mechanism as long as it performs the same function as the piston spring 69 and spring washer stack 74.

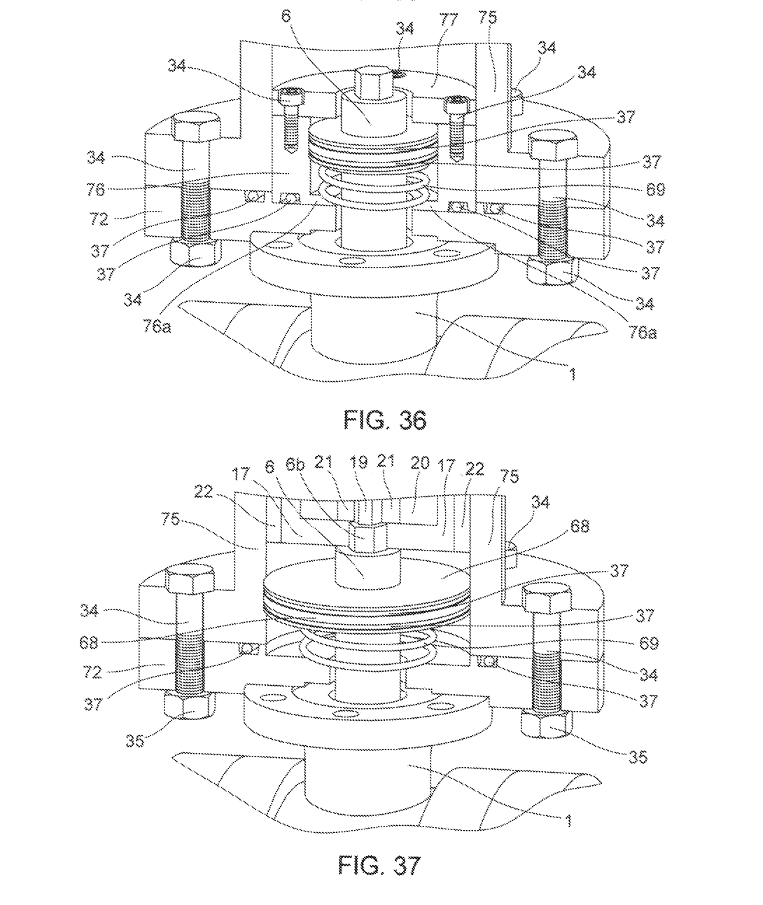

FIG. 36 is a perspective cut-away view of an alternate embodiment of the pressure equalization system comprising a pressure equalization enclosure and pressure equalization lid. In this embodiment, the adapter plate 72 is bolted to the enclosure 75, and the piston 68 is enclosed within a pressure equalization enclosure 76, which in turn is bolted to a pressure equalization lid 77. Thus, rather than biasing the piston spring 68 toward the ceiling 70a of the adapter plate 70 (as in the embodiment shown in FIG. 34), the piston spring 69 biases the piston 68 toward the pressure equalization lid 77. One advantage of this embodiment is that the piston and piston spring are contained within the pressure equalization enclosure 76, which has a lip 76a. The piston 68, piston spring 69 and pressure equalization enclosure 76 may be removed as a single unit by disengaging the enclosure 75 from the adapter plate 72, removing the enclosure 75, and then removing the pressure equalization enclosure 76 (together with the lid 77). Because the piston spring 69 rests on top of the lip 76a, the piston spring 69 and piston 68 will also be removed at the same time. Additionally, with this embodiment, the adapter plate does not need to be removed to service the piston 68, piston seals (O-rings 37), and piston spring 69.

FIG. 37 is a perspective cut-away view of an alternate embodiment of the pressure equalization system in which the piston diameter is maximized. In this embodiment, the pressure equalization enclosure 76 and pressure equalization lid 77 have been omitted, and the outside diameter of the piston 68 has been increased so that it is roughly equal to the inside diameter of the enclosure 76 and the outside diameter of the ring gear 22 of the torque multiplier assembly. This embodiment utilizes a relatively flat adapter plate 72 without a top portion 70b (see FIG. 34), and the piston spring 69 is situated on top of the adapter plate 2 rather than directly on top of the valve body 1, as shown in FIG. 34; however, the piston spring 69 could also sit directly on top of the valve body 1. The main advantage of this embodiment is that the size of the piston is maximized, thereby increasing the surface area of the piston so that it does not have to travel as far longitudinally to equalize the fluid pressure in the valve body 1 and enclosure 75. This in turn allows the overall valve size to be shorter than in other embodiments where the piston is smaller in diameter.

Rather than surrounding the top portion 70b of the adapter plate 70 (see FIGS. 32 and 34), the inside wall of the enclosure 75 is in direct contact with the piston 68 (and, more specifically, the O-rings 37 in the perimeter of the piston 68). In this embodiment, the piston 68 floats between the carrier 17/ring gear 22 of the torque multiplier assembly and the adapter plate 72. Although a piston spring 69 is shown in FIGS. 36 and 37, the piston spring 69 may be replaced with a spring washer stack 74 or similar mechanism.

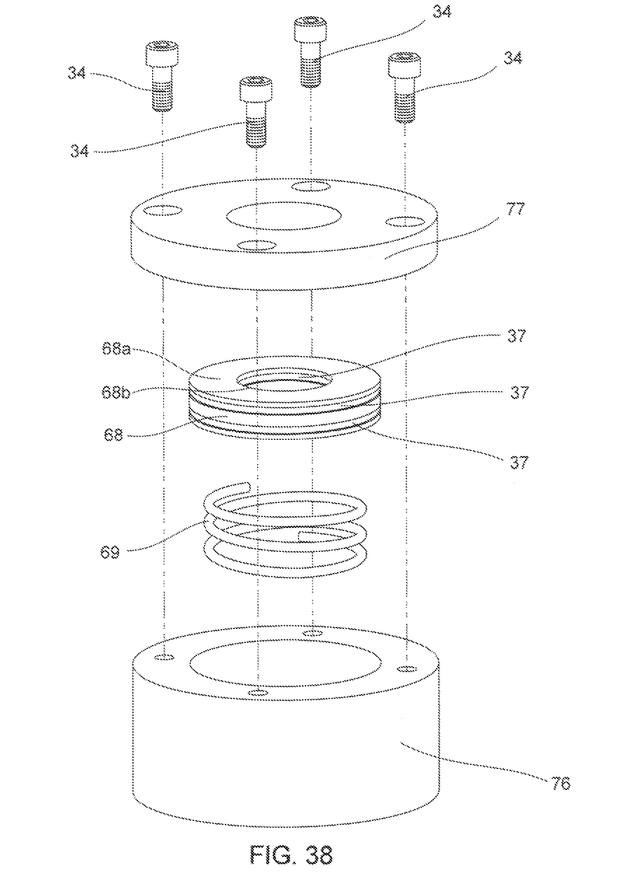

FIG. 38 is an exploded view of the pressure equalization system shown in FIG. 36. As shown in this figure, the inside diameter of the pressure equalization enclosure 76 is roughly the same as the outside diameter of the piston 68, and the outside diameter of the pressure equalization lid 77 is equal to the outside diameter of the pressure equalization enclosure 76. The inside diameter of the aperture 68b located in the center of the piston 68 is roughly equal to the outside diameter of the shaft 6 (see FIG. 36). Note that the center aperture in the pressure equalization lid 77 is slightly larger in diameter than the center aperture in the piston 68 because the center aperture in the piston needs to seal with the shaft 6, whereas the center aperture in the pressure equalization lid 77 needs to be slightly larger to allow grease to flow between the pressure equalization lid 77 and the shall 6.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

### REFERENCES

Shaw, M., Valve World, Vol. 5; Issue 4 (2000) 32-35.
2. Hathaway, N., Valve World, Vol. 2, issue 1 (1997) 41.

We claim:

1. A rotary valve adapter assembly comprising:
(a) an adapter plate configured to attach to a rotary valve body;
(b) a torque multiplier assembly comprising one or more planetary gear subassemblies, each of which comprises a sun gear, a ring gear, and a plurality of planetary gears;
(c) a magnetic actuator assembly comprising two sets of magnetically coupled magnets; and
(d) a shaft comprising two ends; and
(e) a pressure equalization system comprising a piston and a piston spring;
wherein the magnetic actuator assembly interfaces with the torque multiplier assembly such that when the magnets of the magnetic actuator assembly rotate, they cause the sun gear of a first planetary gear subassembly to rotate, thereby causing the planetary gears to walk on the ring gear;
wherein the planetary gears of each planetary gear subassembly are situated within or on a carrier, and when the planetary gears walk on the ring gear, they cause the carrier to rotate;
wherein when the carrier of the first planetary gear subassembly rotates, it causes the sun gear of a second planetary gear subassembly to rotate;
wherein one end of the shaft extends into the carrier of the second planetary gear subassembly such that when the carrier of the second planetary gear subassembly rotates, the shaft also rotates, thereby causing the valve to open and close; and
wherein the piston and piston spring both surround the shaft.

2. The rotary valve adapter assembly of claim 1, wherein the piston is disc-shaped.

3. The rotary valve adapter assembly of claim 1, wherein the piston spring is situated between the valve body and the piston.

4. The rotary valve adapter assembly of claim 1, wherein the piston spring is situated between the adapter plate and the piston.

5. The rotary valve adapter assembly of claim 1, wherein the piston and piston spring are situated within the adapter plate.

6. The rotary valve adapter assembly of claim 1, wherein the piston and piston spring are situated within a pressure equalization enclosure, wherein the pressure equalization enclosure is attached to a pressure equalization lid, wherein the pressure equalization enclosure comprises a lip, and wherein the piston spring is situated between the lip and the piston.

7. The rotary valve adapter assembly of claim 1, wherein the piston and piston spring are situated within a top portion of the adapter plate, wherein the piston has an outside diameter and the top portion of the adapter plate has an inside diameter, and wherein the outside diameter of the piston is roughly equal to the inside diameter of the top portion of the adapter plate.

8. The rotary valve adapter assembly of claim 1, wherein the piston and piston spring are situated within an enclosure, wherein the piston has an outside diameter and the enclosure has an inside diameter, and wherein the outside diameter of the piston is roughly equal to the inside diameter of the enclosure.

9. A rotary valve adapter assembly comprising:
(a) an adapter plate configured to attach to a rotary valve body;
(b) a torque multiplier assembly comprising one or more planetary gear subassemblies, each of which comprises a sun gear, a ring gear, and a plurality of planetary gears;
(c) a magnetic actuator assembly comprising two sets of magnetically coupled magnets; and
(d) a shaft comprising two ends; and
(e) a pressure equalization system comprising a piston and a spring washer stack;
wherein the magnetic actuator assembly interfaces with the torque multiplier assembly such that when the magnets of the magnetic actuator assembly rotate, they cause the sun gear of a first planetary gear subassembly to rotate, thereby causing the planetary gears to walk on the ring gear;
wherein the planetary gears of each planetary gear subassembly are situated within or on a carrier, and when the planetary gears walk on the ring gear, they cause the carrier to rotate;
wherein when the carrier of the first planetary gear subassembly rotates, it causes the sun gear of a second planetary gear subassembly to rotate;
wherein one end of the shaft extends into the carrier of the second planetary gear subassembly such that when the carrier of the second planetary gear subassembly rotates, the shaft also rotates, thereby causing the valve to open and close; and
wherein the piston and spring washer stack both surround the shaft.

10. The rotary valve adapter assembly of claim 9, wherein the piston is disc-shaped.

11. The rotary valve adapter assembly of claim 9, wherein the spring washer stack is situated between the valve body and the spring washer stack.

12. The rotary valve adapter assembly of claim 9, wherein the spring washer stack is situated between the adapter plate and the piston.

13. The rotary valve adapter assembly of claim 9, wherein the piston and spring washer stack are situated within the adapter plate.

14. The rotary valve adapter assembly of claim 9, wherein the piston and spring washer stack are situated within a pressure equalization enclosure, wherein the pressure equalization enclosure is attached to a pressure equalization lid, wherein the pressure equalization enclosure comprises a lip, and wherein the spring washer stack is situated between the lip and the piston.

15. The rotary valve adapter assembly of claim 9, wherein the piston and spring washer stack are situated within a top portion of the adapter plate, wherein the piston has an outside diameter and the top portion of the adapter plate has an inside diameter, and wherein the outside diameter of the piston is roughly equal to the inside diameter of the top portion of the adapter plate.

16. The rotary valve adapter assembly of claim 9, wherein the piston and spring washer stack are situated within an enclosure, wherein the piston has an outside diameter and the enclosure has an inside diameter, and wherein the outside diameter of the piston is roughly equal to the inside diameter of the enclosure.

17. A rotary valve adapter assembly comprising:
(a) an adapter plate configured to attach to a rotary valve body;
(b) a torque multiplier assembly comprising a planetary gear subassembly having a sun gear, a ring gear, and a plurality of planetary gears;
(c) a magnetic actuator assembly comprising two sets of magnetically coupled magnets; and
(d) a shaft comprising two ends;
(e) a pressure equalization system comprising a piston and a piston spring;
wherein the magnetic actuator assembly interfaces with the torque multiplier assembly such that when the magnets of the magnetic actuator assembly rotate, they cause the sun gear of the planetary gear subassembly to rotate, thereby causing the planetary gears to walk on the ring gear;
wherein the planetary gears of the planetary gear subassembly are situated within or on a carrier, and when the planetary gears walk on the ring gear, they cause the carrier to rotate; and
wherein one end of the shaft extends into the carrier of the planetary gear subassembly such that when the carrier of the planetary gear subassembly rotates, the shaft also rotates, thereby causing the valve to open and close; and
wherein the piston and piston spring both surround the shaft.

18. The rotary valve adapter assembly of claim 17, wherein the piston is disc-shaped.

19. The rotary valve adapter assembly of claim 17, wherein the piston spring is situated between the valve body and the piston.

20. The rotary valve adapter assembly of claim 17, wherein the piston spring is situated between the adapter plate and the piston.

21. The rotary valve adapter assembly of claim 17, wherein the piston and piston spring are situated within the adapter plate.

22. The rotary valve adapter assembly of claim 17, wherein the piston and piston spring are situated within a pressure equalization enclosure, wherein the pressure equalization enclosure is attached to a pressure equalization lid, wherein the pressure equalization enclosure comprises a lip, and wherein the piston spring is situated between the lip and the piston.

23. The rotary valve adapter assembly of claim 17, wherein the piston and piston spring are situated within a top portion of the adapter plate, wherein the piston has an outside diameter and the top portion of the adapter plate has an inside diameter, and wherein the outside diameter of the piston is roughly equal to the inside diameter of the top portion of the adapter plate.

24. The rotary valve adapter assembly of claim 17, wherein the piston and piston spring are situated within an enclosure, wherein the piston has an outside diameter and the enclosure has an inside diameter, and wherein the outside diameter of the piston is roughly equal to the inside diameter of the enclosure.

25. A rotary valve adapter assembly comprising:
(a) an adapter plate configured to attach to a rotary valve body;
(b) a torque multiplier assembly comprising a planetary gear subassembly having a sun gear, a ring gear, and a plurality of planetary gears;
(c) a magnetic actuator assembly comprising two sets of magnetically coupled magnets; and
(d) a shaft comprising two ends;
(e) a pressure equalization system comprising a piston and a spring washer stack;
wherein the magnetic actuator assembly interfaces with the torque multiplier assembly such that when the magnets of the magnetic actuator assembly rotate, they cause the sun gear of the planetary gear subassembly to rotate, thereby causing the planetary gears to walk on the ring gear;
wherein the planetary gears of the planetary gear subassembly are situated within or on a carrier, and when the planetary gears walk on the ring gear, they cause the carrier to rotate; and
wherein one end of the shaft extends into the carrier of the planetary gear subassembly such that when the carrier of the planetary gear subassembly rotates, the shaft also rotates, thereby causing the valve to open and close; and
wherein the piston and spring washer stack both surround the shaft.

26. The rotary valve adapter assembly of claim 25, wherein the piston is disc-shaped.

27. The rotary valve adapter assembly of claim 25, wherein the spring washer stack is situated between the valve body and the spring washer stack.

28. The rotary valve adapter assembly of claim 25, wherein the spring washer stack is situated between the adapter plate and the piston.

29. The rotary valve adapter assembly of claim 25, wherein the piston and spring washer stack are situated within the adapter plate.

30. The rotary valve adapter assembly of claim 25, wherein the piston and spring washer stack are situated within a pressure equalization, enclosure, wherein the pressure equalization enclosure is attached to a pressure equalization lid, wherein the pressure equalization enclosure comprises a lip, and wherein the spring washer stack is situated between the lip and the piston.

31. The rotary valve adapter assembly of claim 25, wherein the piston and spring washer stack are situated within a top portion of the adapter plate, wherein the piston has an outside diameter and the top portion of the adapter plate has an inside diameter, and wherein the outside diameter of the piston is roughly equal to the inside diameter of the top portion of the adapter plate.

32. The rotary valve adapter assembly of claim 25, wherein the piston and spring washer stack are situated within an enclosure, wherein the piston has an outside diameter and the enclosure has an inside diameter, and wherein the outside diameter of the piston is roughly equal to the inside diameter of the enclosure.
